(19) United States
(12) Patent Application Publication
(10) Pub. No.: US 2023/0348718 A1
(43) Pub. Date: Nov. 2, 2023

(54) LIGHT-FILTERING MATERIALS FOR BIOMATERIAL INTEGRATION AND METHODS THEREOF

(71) Applicant: Johnson & Johnson Vision Care, Inc., Jacksonville, FL (US)

(72) Inventors: Frank Gu, Toronto (CA); Aaron Joshua Clasky, Toronto (CA); Paul Chen, Toronto (CA)

(21) Appl. No.: 17/661,110

(22) Filed: Apr. 28, 2022

(51) Int. Cl. C08L 83/04; G02C 7/10; G02C 7/04

(52) U.S. Cl. CPC C08L 83/04; G02C 7/10; G02C 7/04; C08L 2203/02

(57) ABSTRACT

A composition for light filtering, the composition comprising: a base material; a plurality of nanoparticles dispersed in the base material, wherein the plurality of nanoparticles exhibit a peak light absorption value in the range of about 650 nm to about 800 nm; a chemical dye dispersed in the base material, the chemical dye having a spectral peak that is at least partially quenched by the filtering of the spectral curve of the nanoparticles; an anchoring mechanism dispersed in the base material, the anchoring mechanism comprising methacryloyl-derived monomer; and a nanoparticle coating material disposed on at least a portion of the plurality of nanoparticles.

### TECHNICAL FIELD

This application generally relates to optical filters. More particularly, this application relates to nanoparticles configured for filtering light.

### BACKGROUND

Selective light blocking is desirable for a large variety of soft biomaterials, including contact lenses. For safety, therapy, and cosmetics there is a strong need for biomaterials to be able to block specific ranges of wavelengths.

Current commercial contact lenses adjust the curvature of the eye and/or the refractive index to improve focusing. However, such commercially available contact lenses do not improve other aspects of vision such as color perception. Impaired color perception/discrimination can significantly impact a person's quality of life. Traditionally, contact lens gel has been used for specific light blocking. However, while specific light blocking using contact lens gel may have beneficial outcomes, the resultant color intensity of the contact lens gel is generally cosmetically undesirable, since it is often bright (due to the use of fluorescent dyes).

Further, while approaches to selective light blocking exist, there are no solutions that can disperse evenly within a biomaterial, can be tuned to different wavelengths of interest without changing the fundamental mechanism, can block light with minimal fluorescence, can withstand long-term storage and autoclaving, and/or can be readily adopted commercially.

A method describing the dispersion of metal nanoparticles for optical filtering in sunglasses is described in US 2007/0298242A1. Gold nanoparticles or dyes are dispersed in a polymer matrix, and the composite either acts as a lens itself or is used as a coating on one or both faces of a lens. US 2007/0298242A1 does not disclose information pertaining to the immobilization of the light blocking materials within the polymer matrix requisite for light blocking material integration into soft materials.

Another example of incorporating nanoparticles into polymer matrices is described in US20080203592A1 wherein a dry hydrogel contact lens is hydrated in a hydrating solution, wherein the hydrating solution comprises silver ions, silver nanoparticles, or combinations thereof, a lubricant or wetting agent, or combinations thereof. The silver nanoparticles and/or the lubricant or wetting agent are adsorbed onto and/or entrapped in the hydrogel contact lens during the extraction step and/or the hydrating step. While the method described may be translatable to gold nanoparticles and/or dyes, the patent does not disclose information pertaining to light blocking materials or to the chemical embedding of these materials in the final product. The nanoparticles are added after the contact lens has been cured which has implications for nanoparticle distribution within the contact lens.

Methods for imbuing contact lenses with specific light blocking capabilities using rhodamine dyes have been described in a paper by Badawy et al, 2018. The study involves the incubation of contact lenses in solutions of Rhodamine B dye dissolved in water to produce tinted contact lenses to treat colorblindness. Similar to US20080203592A1, uptake of the light blocking materials depends on passive diffusion into the contact lens and the publication does not endeavor to embed the dyes into the contact lens via other processes. The lack of light blocking material integration into the contact lens leads to depletion of the dyes in the contact lens following incubation in phosphate-buffered saline (PBS) The publication also does not demonstrate that different wavelengths can be targeted using the same method. The variations in dyes required to produce light blocking materials at different wavelengths may influence passive uptake into the biomaterial.

However, improvements over prior art methods and materials are needed.

### SUMMARY

Disclosed herein are systems, compositions, and methods for light filtering.

One general aspect includes a composition for light filtering. The composition also includes a base material; a plurality of gold nanoparticles dispersed in the base material, where the plurality of gold nanoparticles exhibit a peak light absorption value in the range of about 650 nm to about 800 nm; a chemical dye dispersed in the base material, the chemical dye having an emission peak that at least partially overlaps with the peak light absorption of the plurality of gold nanoparticles; and, a nanoparticle coating material disposed on at least a portion of the plurality of gold nanoparticles.

One general aspect includes a composition for light filtering. The composition also includes a base material; a plurality of nanoparticles dispersed in the base material, where the plurality of nanoparticles exhibit a peak light absorption value in the range of about 650 nm to about 800 nm; a chemical dye dispersed in the base material, the chemical dye having an abortion peak in the range of about 530 nm to about 560 nm; and a nanoparticle coating material disposed on at least a portion of the plurality of nanoparticles.

One general aspect includes a contact lens comprising a composition for light filtering as described herein, wherein the contact lens is a free radical reaction product of a reactive mixture comprising: one or more silicone-containing components and one or more hydrophilic components, the contact lens having a water content of at least about 20 weight percent, preferably at least about weight 30 percent, and an oxygen permeability of at least about 80 barrers, preferably at least about 100 barrers.

### BRIEF DESCRIPTION OF THE DRAWINGS

The following drawings show generally, by way of example, but not by way of limitation, various examples discussed in the present disclosure. In the drawings:

FIGS. 1A-IC depict a surface modification strategy according to embodiments of the disclosure.

FIGS. 2A-2B depict selection of gold nanostars as the platform for the light blocking material according to embodiments of the disclosure.

FIG. 3 displays Ultraviolet-Visible (UV-Vis) spectra of nanoparticles synthesized with varying quanitites of seed.

FIGS. 4A-4D display the effect of seed addition on nanoparticle morphology.

FIGS. 5A-5B depict spectra of dye-nanoparticle (dye-NP) light blockers in solution according to embodiments of the disclosure.

FIG. 6 depicts a color profile of dye-NP light blocker compared to existing methods according to embodiments of the disclosure.

FIG. 7 depicts an Ultraviolet-Visible (UV-Vis) spectrum of Rhodamine 6G nanoparticle light filters.

FIG. 8 depicts an Ultraviolet-Visible (UV-Vis) spectrum of Rhodamine B nanoparticle light filters.

FIG. 9 depicts an Ultraviolet-Visible (UV-Vis) spectrum of tetramethylrhodamine (TRITC) nanoparticle light filters.

FIG. 10 depicts an Ultraviolet-Visible (UV-Vis) spectrum of 5-carboxy-tetramethylrhodamine nanoparticle light filters.

### DETAILED DESCRIPTION

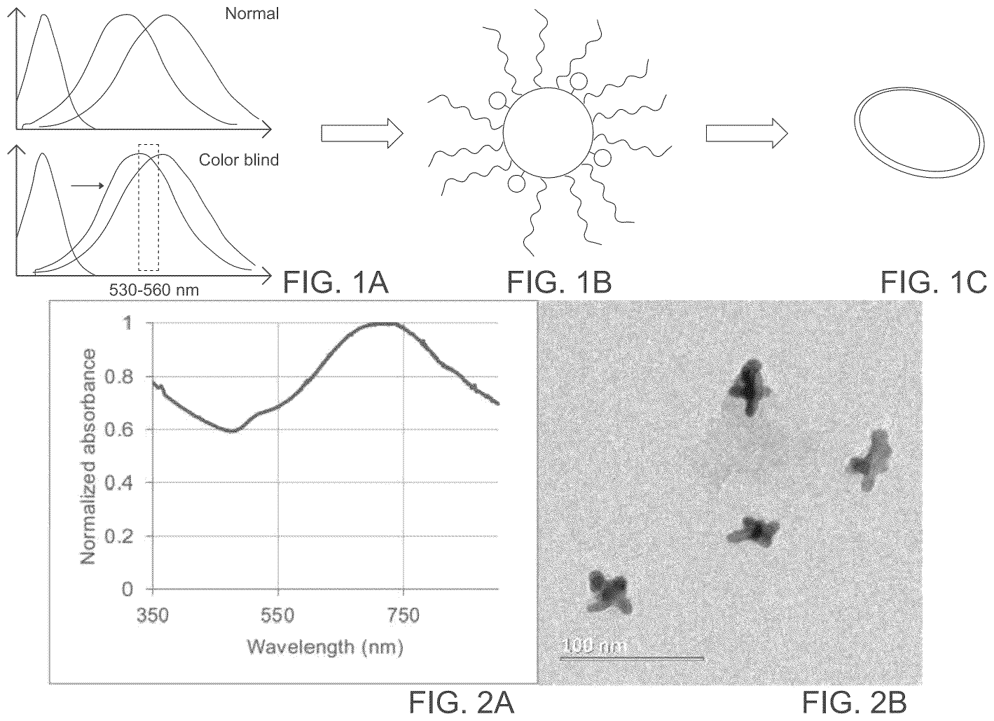

Filtering (e.g., blocking_specific ranges of light may help to improve color perception. As a non-limiting example, filtering light in the region between the red and green cones can help improve contrast and color perception for people with red-green colorblindness, as shown in FIG. 1A. Organic dyes are well tailored to blocking very narrow ranges of the visible light spectrum. However, they suffer from leakage over time (since they are not trapped within the contact lens matrix) and poor patient compliance (for being fluorescent and too brightly colored). Since individual needs can vary drastically, a mechanism by which specific light filtering is achieved should be modular and tunable for different wavelengths.

The current disclosure relates to nanoparticles. Such nanoparticles may exhibit tunable photophysical properties. By exhibiting tunable photophysical properties, nanoparticles may absorb, scatter, and/or extinguish specific wavelengths of light. Such wavelengths may fall anywhere in the visible spectrum. The nanoparticles may be integrated as tunable optical filters in optically transparent substrates to produce devices. Such devices may comprise ophthalmic devices, though other devices are possible. As a non-limiting example, ophthalmic devices may further comprise contact lenses. Integration of a light filtering material into a contact lens may require that such a material be stable and retained for long periods of time. As a result, there exists a need to develop light filtering materials with specificity towards certain wavelengths, decreased color intensity as compared with traditional light filtering contact lens gels, and long-term stability and retention within gel-like medical devices.

The present disclosure provides light-blocking materials for biomaterial integration and methods thereof. The present disclosure addresses key gaps in current light-blocking techniques and materials for contact lenses. A method of providing light-blocking materials for biomaterial integration comprises selecting a nanoparticle. Such a nanoparticle may comprise a gold nanoparticle. Such a gold nanoparticle may further comprise a specified shape. The current disclosure further relates to a chemical dye, (e g, a dye used in food preparation or coloration). The current disclosure further relates to a stabilizing mechanism. Such a stabilizing mechanism may comprise a nanoparticle coating material configured to stabilize the selected nanoparticle. The current disclosure relates to a coupling of a nanoparticle and a chemical dye. Such a coupling may comprise a chemical bond A combination of a nanoparticle and a chemical dye enables specific light filtering with a less intense color. The decrease in color intensity of the material may be due to the fluorescence of the chemical dye being quenched by the nanoparticle. The chemical dye may be in close proximity to the nanoparticle so as to achieve fluorescence quenching. Fluorescence quenching is known in the art and may occur by a gold nanoparticle absorbing light at a sufficiently longer wavelength than the initial light emitted by a dye. Thus, method may comprise using a crosslinker to chemically attach a nanoparticle to a chemical dye. A non-limiting example of a crosslinker may comprise a short-chain thiol. The current disclosure further relates to a stabilizing mechanism. A stabilizing mechanism may enhance stabilizing qualities associated with a chemical dye. A stabilizing mechanism may partially replace a chemical dye conjugated to a nanoparticle. A stabilizing mechanism may comprise a long-chain polymer. A long-chain polymer may stabilize a nanoparticle through increased steric hindrance A stabilizing mechanism may also be biocompatible and compatible with the gel material Such compatibility may enable a homogeneous dispersion of nanoparticles in a biomaterial. A stabilizing mechanism may also intercalate with the chains of the biomaterial via chain entanglement, securing the nanoparticles in the gel long-term Additional capabilities, such as different dyes (or combinations thereof) to target different wavelengths of interest may be used. Additional shapes of gold nanoparticles to quench fluorescence of varying dyes may be used.

The present disclosure relates to nanoparticles such as metal nanoparticles, and more particularly to gold nanoparticles, for example. Reference made to gold nanoparticles may be applied to other nanoparticles, including metal nanoparticles. A nanoparticle may be a gold nanoparticle. A gold nanoparticle may be a star-shaped gold nanoparticle that blocks light in the range of about 650 nm up to about 800 nm. Such an absorbance profile may cause a solution of star-shaped gold nanoparticles to appear blue. An absorbance profile of gold nanoparticles depends on morphology. Morphology may comprise size and shape. Thus, nanoparticles may be modified to optimize fluorescence quenching, or to tune the light filtering spectrum of a final product. Such modifications may include altering morphology. The selection of a nanoparticle for use in the herein described methods and materials enables control over the nanoparticles' light filtering characteristics.

The current disclosure relates to a chemical dye. A chemical dye may comprise a rhodamine-based dye with a peak absorbance at 554 nm. As a non-limiting example, a dye may comprise Rhodamine B. Rhodamine B is non-toxic, highly water-soluble and heat- and light-stable, enabling long-term specific light filtering in a biomaterial. The dye may be fluorescent. The fluorescence of a dye may comprise an emission peak that may substantially overlap with the absorbance peak of a gold nanoparticle, leading to fluorescence quenching. Providing a combination of a gold nanoparticle and dye as described herein may result in a material having a muted color when compared with Rhodamine B alone, any such other dye having a bright, fluorescent color, or any such other commercially available light filtering materials for contact lenses. In some embodiments, the final color may comprise a purple color. The identity of the dye can be reasonably changed to or combined with any other dye (e.g, Rhodamine 6G) to tune light filtering characteristics.

The current disclosure further relates to a stabilizing mechanism. A stabilizing mechanism may comprise a nanoparticle coating A nanoparticle coating material may comprise a polymer. Such a polymer may comprise a terminally thiolated poly(ethylene glycol) (PEG) polymer, though other such polymers known in the art may be used. A PEG polymer may stabilize the gold nanoparticles via steric hindrance. PEG is a highly stable, biocompatible polymer that can disperse well in both aqueous media and contact lens precursor material. As a non-limiting example, a contact lens precursor may comprise HEMA-based Etafilcon A.

Accordingly, methods and materials of the present disclosure relate to use of a combination of chemical dyes and gold nanoparticles to produce specific light filtering materials. Fluorescence quenching may be a result of proximity of a chemical dye to a nanoparticle surface. The current disclosure relates to a method of conjugating a dye(s) to a surface of gold nanoparticles provides. Such conjugation may result in reduced fluorescence (and thus color intensity) of a light filtering material A light filtering material such conjugated may maintain light filtering capability. Use of a specific gold nanoparticle shape further enables such fluorescence quenching.

The methods and materials of the present disclosure may be customized for cosmetic and/or therapeutic contact lenses Chemical integration into a biomaterial may allow for immobilization and selective patterning of light filtering materials. The methods and materials of the current disclosure relate to integration of a light filtering material into a variety of biomaterials. The methods and materials of the current disclosure further relate to combinations of a variety of dyes and/or a variety of gold nanoparticles. Such combinations may enable tunable, highly complex light filtering spectra. A variety of gold nanoparticles may comprise a variety of gold nanoparticles of various shapes The methods and materials of the current disclosure relate to long-term stability and material integration. Long-term stability and material integration enables passive sensing applications and/or labeling of commercial products, though other uses exist.

The current disclosure relates to an anchoring mechanism. Such mechanism may allow nanoparticles to be chemically integrated into a biomaterial (as opposed to physical integration via chain entanglement). Such a mechanism may comprise a polymer. As a non-limiting example, a methacryloyl-derived monomer (glycidyl methacrylate) may be selected as an anchoring mechanism for incorporation of the materials described herein into a biomaterial. Such a biomaterial my comprise a HEMA-based contact lens. The methacrylate chemical group comprises a C═C double bond that may participate in the UV-triggered polymerization of the contact lens. Moreover, since methacrylate is a typical component of HEMA-based contact lenses. Integration of these light filtering materials using methacrylate does not significantly affect the final product. The method may comprise maintaining the clarity and transparency of the final material by using such an anchoring mechanism. As a further non-limiting example, poly(vinyl alcohol) (PVA) may be utilized to achieve chemical integration. PVA may additionally stabilize the nanoparticles. PVA may also provide an anchoring mechanism that can be attached to a free hydroxyl (—OH) group for chemical integration into a biomaterial. Other polymers known in the art may also be used.

The method may further comprise providing a nanoparticle coating material. For instance, the nanoparticle coating material may be a poly(vinyl alcohol) (PVA). PVA is known to be stable and highly compatible with HEMA-based contact lens materials PVA may stabilize gold nanoparticles, conjugate the chemical dye via carbonyldiimidazole-mediated esterification, and conjugate the monomer via transesterification.

The present disclosure relates to a base material. Such a base material may comprise, a biomaterial, a biomaterial matrix, a hydrogel, and other such materials known in the art. Non-limiting examples of base materials are described below. The disclosure further relates to nanoparticles. Such nanoparticles may comprise gold. Gold nanoparticles may be grown from gold seeds, though other methods of synthesis are known in the art Such nanoparticles may comprise shapes. Such shapes may be anisotropic. Such shapes may comprise star shapes Alternative shapes are known in the art and may comprise, but are not limited to, cubic shape, a nanorod shape, an octahedral shape, a decahedral shape, a cuboctahedral shape, a tetrahedral shape, a rhombic dodecahedral shape, a truncated ditetragonal prismatic shape, or a truncated bitetrahedral shape. Such gold nanoparticles may block light in a variety of ranges. As a non-limiting example, gold nanoparticles may block light in the range of about 650 nm up to about 800 nm. Alternative ranges exist and may include, but are not limited to, about 675 nm up to about 800 nm, about 700 nm up to about 800 nm, about 725 nm up to about 800 nm, about 750 nm up to about 800 nm, about 775 nm up to about 800 nm, about 650 nm up to about 775 nm, about 650 nm up to about 750 nm, about 650 nm up to about 725 nm, about 650 nm up to about 700 nm, or about 650 nm up to about 675 nm. The present disclosure further relates to a chemical dye. A chemical dye may block light in a range of about 530 nm up to about 560 nm. Alternative ranges exist and may include, but are not limited to, about 540 nm up to about 560 nm, about 550 nm up to about 560 nm, about 530 nm up to about 550 nm, about 530 nm up to about 550 nm, about or 530 nm up to about 540 nm. A chemical dye may further emit light. Light emission may occur via fluorescence, phosphorescence, and other known phenomenon. The emission of a chemical dye may occur such that it sufficiently overlaps with the light filtering ranges of a gold nanoparticle. Such a chemical dye may comprise an organic chemical dye. As non-limiting examples, an organic chemical dye may comprise a rhodamine-based dye including, but not limited to, Rhodamine 6G, Rhodamine B, tetramethylrhodamine (TRITC), and 5-carboxy-tetramethylrhodamine. A chemical dye may also comprise any dye that can be functionalized by N-hydroxysuccinimide (NHS). The present disclosure further relates to a nanoparticle coating material (i.e. a stabilizing mechanism). Such stabilizing mechanism may comprise a polymer. Such polymers may comprise a variety of molecular weights. Such polymer may comprise a terminally thiolated poly(ethyleneglycol) (PEG-SH). Alternative polymers are known in the art and may comprise, but are not limited to, poly(ethylene glycol) (PEG), polycarbonate, poly(vinyl alcohol) (PVA), polyvinylpyrrolidone (PVP), polystyrene (PS), polycaprolactone (PCL), ethylene oligomers or polyethylene (PE), polypropylene (PP), and poly(methyl methacrylate) (PMMA), as well as copolymers or blends thereof. Such polymer may comprise PVP with molecular weights of about 55 kDa up to about 1300 kDa. The present disclosure relates to a method of coupling a gold nanoparticle to a stabilizing mechanism. Coupling may occur through chemical conjugation Such coupling may be selective. Such coupling may enhance colloidal and/or thermal stability of a nanoparticle, as well as biocompatibility. The present disclosure relates to an anchoring mechanism. Such anchoring mechanism may comprise a methacrylate.

Such anchoring mechanism may comprise a methacryloyl-derived monomer. As a non-limiting example, an anchoring mechanism may comprise polyvinyl alcohol (PVA) or glycidyl methacrylate. Such a methacrylate may further comprise a thiolated methacrylate dimer. Such thiolated methacrylate dimer may comprise bis(2-methacryloyl)oxyethyl disulfide (i.e. DSDMA), though other examples exist Other such examples may include, but are not limited to, ethylene glycol dimethacrylate (EGDMA), tetraethylene glycol dimethacrylate (TEGDMA), trimethylolpropane timethacrylate (TMPTMA), triallyl cyanurate (TAC), glycerol trimethacrylate, methacryloxyethyl vinylcarbonate (HEMAVc), allyl methacrylate, methylene bisacrylamide (MBA), polyethylene glycol dimethacrylate, 1,4-phenylene diacrylate, 1,4-phenylene dimethacrylate, 2,2-bis(4-methacryloxyphenyl)-propane, 2,2-bis[4-(2-acryloxyethoxy)phenyl]propane, 2,2-bis[4-(2-hydroxy-3-methacryloxypropoxy)-phenyl]propane, and 4-vinylbenzyl methacrylate. An anchoring mechanism may also comprise a polymer. The present disclosure relates to a method of coupling a gold nanoparticle to an anchoring mechanism. The present disclosure further relates to the coupling of an anchoring mechanism to an organic dye. In such coupling, an anchoring mechanism coupled to an organic dye may further couple to a gold nanoparticle. Coupling may occur through chemical conjugation. Such coupling may be selective. Such coupling may enhance colloidal and/or thermal stability of a nanoparticle, as well as biocompatibility. The present disclosure further relates to a method of coupling an anchoring mechanism to a base material. A base material may comprise biomaterials, as described above. Conjugation of an anchoring mechanism to a gold nanoparticle and a base material may comprise a crosslinking. Such crosslinking may facilitate integration into a base material of a nanoparticle.

The present disclosure relates to a composition, wherein a composition may comprise a base material, nanoparticles, a chemical dye, a nanoparticle coating material (i.e. a stabilizing mechanism), an anchoring mechanism, or any combination thereof. Such composition may comprise a chemical dye that emits light with an emission spectrum sufficiently overlapping a gold nanoparticle to which it is conjugated. This may lead to quenching. Nanoparticle light absorption may be tuned through tuning nanoparticle morphology. Morphology may be tuned by configuring an aspect ratio defined by a quotient of major and minor axes length, a volume, sharpness, and/or other related features. Aspect ratios may be tuned to about 1.9 up to about 2.9, though other such aspect ratios may be possible. As non-limiting examples, aspect ratios may range from about 1.9 up to about 2.8, about 1.9 up to about 2.7, about 1.9 up to about 2.6, about 1.9 up to about 2.5, about 1.9 up to about 2.4, about 1.9 up to about 2.3, about 1.9 up to about 2.2, about 1.9 up to about 2.1, about 1.9 up to about 2.0, about 2.0 up to about 2.8, about 2.0 up to about 2.7, about 2.0 up to about 2.6, about 2.0 up to about 2.5, about 2.0 up to about 2.4, about 2.0 up to about 2.3, about 2.0 up to about 2.2, or about 2.0 up to about 2.1. Volumes may be tuned to about 250 nm³ up to about 30,000 nm³, though other such volumes may be possible. As non-limiting examples, volumes may be tuned to about 1,250 nm³ up to about 30,000 nm³, about 2,250 nm³ up to about 30,000 nm³, about 3,250 nm³ up to about 30,000 nm², about 4,250 nm³ up to about 30,000 nm, about 5,250 nm² up to about 30,000 nm³, about 6,250 nm³ up to about 30,000 nm³, about 7,250 nm³ up to about 30,000 nm³, about 8,250 nm³ up to about 30,000 nm³, about 9,250 nm³ up to about 30,000 nm³, about 10,250 nm³ up to about 30,000 nm³, about 11,250 nm³ up to about 30,000 nm, about 12,250 nm³ up to about 30,000 nm³, about 13,250 nm³ up to about 30,000 nm², about 14,250 nm³ up to about 30,000 nm³, about 15,250 nm³ up to about 30,000 nm³, about 16,250 nm³ up to about 30,000 nm³, about 17,250 nm³ up to about 30,000 nm³, about 18,250 nm³ up to about 30,000 nm³, about 19,250 nm³ up to about 30,000 nm³, about 20,250 nm³ up to about 30,000 nm, about 21,250 nm, up to about 30,000 nm³, about 22,250 nm³ up to about 30,000 nm³, about 23,250 nm³ up to about 30,000 nm³, about 24,250 nm³ up to about 30,000 nm³, about 25,250 nm³ up to about 30,000 nm³, about 26,250 nm³ up to about 30,000 nm³, about 27,250 nm³ up to about 30,000 nm³, about 28,250 nm³ up to about 30,000 nm³, or about 29,250 nm³ up to about 30,000 nm³.

Final light-blocking profiles may be tuned through use of varying nanoparticles, chemical dyes, nanoparticle coating materials (i.e. stabilizing mechanisms), anchoring mechanisms, and combinations thereof. Such tuning may result in a Full-Width at Half Maximum (FWHM) value of about 58 nm up to about 118 nm. As non-limiting examples, FWHM values may range from about 58 nm up to about 108 nm, about 58 nm up to about 98 nm, about 58 nm up to about 88 nm, about 58 nm up to about 78 nm, or about 58 nm up to about 68 nm.

Additional capabilities relating to the current disclosure exist. The present disclosure additionally relates to a variety of polymers that may be grafted to the surface of nanoparticles. The use of varying polymers may enable the integration of nanoparticles into a variety of biomaterials Such nanoparticles, may comprise a variety of shapes. The disclosure is therefore independent of a specific biomaterial. Moreover, the disclosure relates to the incorporation of a variety of shapes of nanoparticles further comprising a variety of stabilizing mechanisms into virtually any biomaterial of interest Non-limiting examples of biomaterials may comprise hydrogel or silicone hydrogel material suitable for use in the formation of a soft contact lens Such materials are known in the art and include Group 1-Low Water (<50% H2O) Nonionic Hydrogel Polymers (e.g., tefilcon, tetrafilcon A, crofilcon, helfilcon A, helfilcon B, mafilcon, polymacon, hioxifilcon B); Group 2-High Water (>50% 1-120) Nonionic Hydrogel Polymers (e.g., surfilcon A, lidofilcon A, lidofilcon B, netrafilcon A, hetilcon B, alphafilcon A, omatilcon A, omafilcon B, vasurfilcon A, hioxifilcon A, hioxifilcon D, nelfilcon A, hilafilcon A, hilafilcon B, acofilcon A, nesofilcon A), Group 3-Low Water (<50% 1H120) Ionic Hydrogel Polymers (e.g., bufilcon A, deltafilcon A, phemfilcon); Group 4-High Water (>50% H2O) Ionic Hydrogel Polymers (e.g., bufilcon A, perfilcon A, etatilcon A, focofilcon A, ocufilcon A, ocufilcon B, ocufilcon C, ocufilcon D, ocufilcon E, ocufilcon F, phemfilcon A, methafilcon A, methafilcon B, vilfilcon A), and Silicone Hydrogel Polymers (e.g., lotrafilcon A, lotrafilcon B, galyfilcon A, senofilcon A, senofilcon C, sifilcon A, comfilcon A, enfilcon A, balatilcon A, delefilcon A, narafilcon B, narafilcon A, stenfilcon A, somofilcon A, fanfilcon A, samfilcon A, elastofilcon).

### Definitions

It is to be understood that the invention is not limited to the details of construction or process steps set forth in the following description. The invention is capable of other embodiments and of being practiced or being carried out in various ways using the teaching herein.

With respect to the terms used in this disclosure, the following definitions are provided.

Unless defined otherwise, all technical and scientific terms used herein have the same meaning as commonly understood by one of ordinary skill in the art to which the invention belongs. The polymer definitions are consistent with those disclosed in the Compendium of Polymer Terminology and Nomenclature, IUPAC Recommendations 2008, edited by Richard G Jones, Jaroslav Kahovec, Robert Stepto, Edward S. Wilks, Michael Hess, Tatsuki Kitayama, and W. Val Metanomski. All publications, patent applications, patents, and other references mentioned herein are incorporated by reference.

As used herein, the term “(meth)” designates optional methyl substitution. Thus, a term such as “(meth)acrylates” denotes both methacrylates and acrylates.

The term “individual” includes humans and vertebrates.

The term “ophthalmic device” refers to any device which resides in or on the eye or any part of the eye, including the ocular surface. These devices can provide optical correction, cosmetic enhancement, vision enhancement, therapeutic benefit (for example as bandages) or delivery of active components such as pharmaceutical and nutraceutical components, or a combination of any of the foregoing. Examples of ophthalmic devices include but are not limited to lenses, optical and ocular inserts, including but not limited to punctal plugs, and the like “Lenses” include soft contact lenses, hard contact lenses, hybrid contact lenses, intraocular lenses, and overlay lenses. The ophthalmic device may comprise a contact lens.

The term “contact lens” refers to an ophthalmic device that can be placed on the cornea of an individual's eye. The contact lens may provide corrective, cosmetic, or therapeutic benefit, including wound healing, the delivery of drugs or nutraceuticals, diagnostic evaluation or monitoring, ultraviolet light filtering, visible light or glare reduction, or any combination thereof. A contact lens can be of any appropriate material known in the art and can be a soft lens, a hard lens, or a hybrid lens containing at least two distinct portions with different physical, mechanical, or optical properties, such as modulus, water content, light transmission, or combinations thereof.

The ophthalmic devices and lenses described herein may be comprised of silicone hydrogels or conventional hydrogels. Silicone hydrogels typically include at least one hydrophilic monomer and at least one silicone-containing component that are covalently bound to one another in the cured device.

As used herein, the terms “physical absorption” or “chemical absorption” refer to processes in which atoms, molecules, or particles enter the bulk phase of a gas, liquid, or solid material and are taken up within the volume. Absorption in this manner may be driven by solubility, concentration gradients, temperature, pressure, and other driving forces known in the art.

As used herein, “adsorption” is defined as the deposition of a species onto a surface. The species that gets adsorbed on a surface is known as an adsorbate, and the surface on which adsorption occurs is known as an adsorbent. Examples of adsorbents may comprise clay, silica gel, colloids, metals, nanoparticles etc. Adsorption may occur via chemical or physical adsorption. Chemical adsorption may occur when an adsorbate is held to the an adsorbent via chemical bonds, whereas physical adsorption may occur when an adsorbate is joined to an adsorbent via weak van der Waal's forces.

As used herein, “antibacterial” means intended to kill or reduce the harmful effects of bacteria.

As used herein, “colloid” refers to dispersions of wherein one substance is suspended in another Many examples of colloids in the art contain polymers. In this aspect, polymers may be adsorbed or chemically attached to the surface of particles suspended in the colloid, or the polymers may freely move in the colloidal suspension. The presence of polymers on particles in the suspension may directly relate to “colloidal stability,” wherein “colloidal stability” refers to the tendency of a colloidal suspension to undergo sedimentation. Sedementation would result in the falling of particles out of a colloid. Polymers adsorbed or chemically attached to a particle may affect its colloidal stability.

As used herein, the term “diffusion” refers to the process wherein there is a net flow of matter from one region to another. An example of such process is “surface diffusion,” wherein particles move from one area of the surface of a subject to another area of the same surface. This can be caused by thermal stress or applied pressure.

As used herein, a “surfactant” refers to a substance that, when added to a liquid, reduces its surface tension, thereby increasing its spreading and wetting properties. Typical surfactants may be partly hydrophilic and partly lipophilic.

As used herein, the term “wetting agent” refers to a material that reduces the surface tension of water and thus allows a liquid to more easy spread on or “wet” a surface. The high surface tension of water causes problems in many industrial processes where water-based solutions are used, as the solution is not able to wet the surface it is applied to. Wetting agents are commonly used to reduce the surface tension of water and thus help the water-based solutions to spread.

“Target macromolecule” means the macromolecule being synthesized from the reactive monomer mixture comprising monomers, macromers, prepolymers, cross-linkers, initiators, additives, diluents, and the like.

The term “polymerizable compound” means a compound containing one or more polymerizable groups. The term encompasses, for instance, monomers, macromers, oligomers, prepolymers, cross-linkers, and the like.

“Polymerizable groups” are groups that can undergo chain growth polymerization, such as free radical and/or cationic polymerization, for example a carbon-carbon double bond which can polymerize when subjected to radical polymerization initiation conditions. Non-limiting examples of free radical polymerizable groups include (meth)acrylates, styrenes, vinyl ethers, (meth)acrylamides, N-vinyllactams, N-vinylamides, O-vinylcarbamates, O-vinylcarbonates, and other vinyl groups Preferably, the free radical polymerizable groups comprise (meth)acrylate, (meth)acrylamide, N-vinyl lactam, N-vinylamide, and styryl functional groups, and mixtures of any of the foregoing More preferably, the free radical polymerizable groups comprise (meth)acrylates, (meth)acrylamides, and mixtures thereof. The polymerizable group may be unsubstituted or substituted. For instance, the nitrogen atom in (meth)acrylamide may be bonded to a hydrogen, or the hydrogen may be replaced with alkyl or cycloalkyl (which themselves may be further substituted).

Any type of free radical polymerization may be used including but not limited to bulk, solution, suspension, and emulsion as well as any of the controlled radical polymerization methods such as stable free radical polymerization, nitroxide-mediated living polymerization, atom transfer radical polymerization, reversible addition fragmentation chain transfer polymerization, organotellurium mediated living radical polymerization, and the like.

A “monomer” is a mono-functional molecule which can undergo chain growth polymerization, and in particular, free radical polymerization, thereby creating a repeating unit in the chemical structure of the target macromolecule. Some monomers have di-functional impurities that can act as cross-linking agents. A “hydrophilic monomer” is also a monomer which yields a clear single phase solution when mixed with deionized water at 25° C. at a concentration of 5 weight percent. A “hydrophilic component” is a monomer, macromer, prepolymer, initiator, cross-linker, additive, or polymer which yields a clear single phase solution when mixed with deionized water at 25° C. at a concentration of 5 weight percent. A “hydrophobic component” is a monomer, macromer, prepolymer, initiator, cross-linker, additive, or polymer which is slightly soluble or insoluble in deionized water at 25′ C.

A “macromolecule” is an organic compound having a number average molecular weight of greater than 1500, and may be reactive or non-reactive.

A “macromonomer” or “macromer” is a macromolecule that has one group that can undergo chain growth polymerization, and in particular, free radical polymerization, thereby creating a repeating unit in the chemical structure of the target macromolecule Typically, the chemical structure of the macromer is different than the chemical structure of the target macromolecule, that is, the repeating unit of the macromer's pendent group is different than the repeating unit of the target macromolecule or its mainchain. The difference between a monomer and a macromer is merely one of chemical structure, molecular weight, and molecular weight distribution of the pendent group. As a result, and as used herein, the patent literature occasionally defines monomers as polymerizable compounds having relatively low molecular weights of about 1,500 Daltons or less, which inherently includes some macromers. In particular, monomethacryloxypropyl terminated mono-n-butyl terminated polydimethylsiloxane (molecular weight=500-1500 g/mol) (mPDMS) and mono-(2-hydroxy-3-methacryloxypropyl)-propyl ether terminated mono-n-butyl terminated polydimethylsiloxane (molecular weight=500-1500 g/mol) (OH-mPDMS) may be referred to as monomers or macromers. Furthermore, the patent literature occasionally defines macromers as having one or more polymerizable groups, essentially broadening the common definition of macromer to include prepolymers. As a result, and as used herein, di-functional and multi-functional macromers, prepolymers, and crosslinkers may be used interchangeably.

A “silicone-containing component” is a monomer, macromer, prepolymer, cross-linker, initiator, additive, or polymer in the reactive mixture with at least one silicon-oxygen bond, typically in the form of siloxy groups, siloxane groups, carbosiloxane groups, and mixtures thereof.

Examples of silicone-containing components which are useful in this invention may be found in U.S. Pat. Nos. 3,808,178, 4,120,570, 4,136,250, 4,153,641, 4,740,533, 5,034,461, 5,070,215, 5,244,981, 5,314,960, 5,331,067, 5,371,147, 5,760,100, 5,849,811, 5,962,548, 5,965,631, 5,998,498, 6,367,929, 6,822,016, 6,943,203, 6,951,894, 7,052,131, 7,247,692, 7,396,890, 7,461,937, 7,468,398, 7,538,146, 7,553,880, 7,572,841, 7,666,921, 7,691,916, 7,786,185, 7,825,170, 7,915,323, 7,994,356, 8,022,158, 8,163,206, 8,273,802, 8,399,538, 8,415,404, 8,420,711, 8,450,387, 8,487,058, 8,568,626, 8,937,110, 8,937,111, 8,940,812, 8,980,972, 9,056,878, 9,125,808, 9,140,825, 9,156,934, 9,170,349, 9,217,813, 9,244,196, 9,244,197, 9,260,544, 9,297,928, 9,297,929, and European Patent No. 080539. These patents are hereby incorporated by reference in their entireties.

A “polymer” is a target macromolecule composed of the repeating units of the monomers used during polymerization Exemplary polymers may comprise poly(ethylene glycol) (PEG), polycarbonate, poly(vinyl alcohol) (PVA), polyvinylpyrrolidone (PVP), polystyrene (PS), polycaprolactone (PCL), ethylene oligomers or polyethylene (PE), polypropylene (PP), poly(methyl methacrylate) (PMMA) and other polymers known in the art.

As used herein, the term “thermoplastic” refers to a property of polymers, wherein the polymer may be melted, solidified, and then successfully melted and solidified again. This process may be repeated several times for thermoplastic polymers without loss of functionality.

As used herein, the term “thermoset” refers to a property of polymers, wherein a thermoset polymer forms well-defined, irreversible, chemical networks that tend to grow in three dimensional directions through the process of curing, which can either occur due to heating or through the addition of a curing agent, therefore causing a crosslinking formation between its chemical components, and giving the thermoset a strong and rigid structure that can be added to other materials to increase strength. Once a thermoset polymer has formed networks during curing, the polymer cannot be re-cured to set in a different manner.

A “repeating unit” is the smallest group of atoms in a polymer that corresponds to the polymerization of a specific monomer or macromer.

An “initiator” is a molecule that can decompose into radicals which can subsequently react with a monomer to initiate a free radical polymerization reaction. A thermal initiator decomposes at a certain rate depending on the temperature; typical examples are azo compounds such as 1,1′-azobisisobutyronitrile and 4,4′-azobis(4-cyanovaleric acid), peroxides such as benzoyl peroxide, tert-butyl peroxide, tert-butyl hydroperoxide, tert-butyl peroxybenzoate, dicumyl peroxide, and lauroyl peroxide, peracids such as peracetic acid and potassium persulfate as well as various redox systems. A photo-initiator decomposes by a photochemical process; typical examples are derivatives of benzil, benzoin, acetophenone, benzophenone, camphorquinone, and mixtures thereof as well as various monoacyl and bisacyl phosphine oxides and combinations thereof.

A “cross-linking agent” is a di-functional or multi-functional monomer or macromer which can undergo free radical polymerization at two or more locations on the molecule, thereby creating branch points and a polymeric network. Common examples are bis(2-methacryloyl)oxyethyl disulfide (DSDMA), cetyltrimethylammonium bromide (CTAB), cetyltrimethylammonium chloride (CTAC), ethylene glycol dimethacrylate, tetraethylene glycol dimethacrylate, trimethylolpropane trimethacrylate, methylene bisacrylamide, triallyl cyanurate, and the like.

A “prepolymer” is a reaction product of monomers which contains remaining polymerizable groups capable of undergoing further reaction to form a polymer.

A “polymeric network” is a cross-linked macromolecule that can swell but cannot dissolve in solvents. “Hydrogels” are polymeric networks that swell in water or aqueous solutions, typically absorbing at least 10 weight percent water. “Silicone hydrogels” are hydrogels that are made from at least one silicone-containing component with at least one hydrophilic component. Hydrophilic components may also include non-reactive polymers.

“Conventional hydrogels” refer to polymeric networks made from components without any siloxy, siloxane or carbosiloxane groups Conventional hydrogels are prepared from reactive mixtures comprising hydrophilic monomers. Examples include 2-hydroxyethyl methacrylate (“HEMA”), N-vinyl pyrrolidone (“NVP”), N, N-dimethylacrylamide (“DMA”) or vinyl acetate U.S. Pat. Nos. 4,436,887, 4,495,313, 4,889,664, 5,006,622, 5,039,459, 5,236,969, 5,270,418, 5,298,533, 5,824,719, 6,420,453, 6,423,761, 6,767,979, 7,934,830, 8,138,290, and 8,389,597 disclose the formation of conventional hydrogels. Commercially available conventional hydrogels include, but are not limited to, etafilcon, genfilcon, hilafilcon, lenefilcon, nesofilcon, omafilcon, polymacon, and vifilcon, including all of their variants.

“Silicone hydrogels” refer to polymeric networks made from at least one hydrophilic component and at least one silicone-containing component Examples of silicone hydrogels include acquafilcon, asmofilcon, balafilcon, comfilcon, delefilcon, enfilcon, falcon, fanfilcon, formofilcon, galyfilcon, lotrafilcon, narafilcon, riofilcon, samfilcon, senofilcon, somofilcon, and stenfilcon, including all of their variants, as well as silicone hydrogels as prepared in U.S. Pat. Nos. 4,659,782, 4,659,783, 5,244,981, 5,314,960, 5,331,067, 5,371,147, 5,998,498, 6,087,415, 5,760,100, 5,776,999, 5,789,461, 5,849,811, 5,965,631, 6,367,929, 6,822,016, 6,867,245, 6,943,203, 7,247,692, 7,249,848, 7,553,880, 7,666,921, 7,786,185, 7,956,131, 8,022,158, 8,273,802, 8,399,538, 8,470,906, 8,450,387, 8,487,058, 8,507,577, 8,637,621, 8,703,891, 8,937,110, 8,937,111, 8,940,812, 9,056,878, 9,057,821, 9,125,808, 9,140,825, 9,156,934, 9,170,349, 9,244,196, 9,244,197, 9,260,544, 9,297,928, 9,297,929 as well as WO 03/22321, WO 2008/061992, and US 2010/0048847. These patents are hereby incorporated by reference in their entireties.

As used herein, “gel-like” refers to a substance having properties generally relating to those associated with a gel. A “gel” may refer to a coherent mass consisting of a liquid in which particles are either dispersed or arranged in a fine network throughout the mass. A gel may be notably elastic or substantially solid and rigid (e.g. silica gel appears as a firm particle) Gels may also be seen as colloids in which the liquid medium has become viscous enough to behave more or less as a solid.

An “interpenetrating polymeric network” comprises two or more networks which are at least partially interlaced on the molecular scale but not covalently bonded to each other and which cannot be separated without braking chemical bonds. A “semi-interpenetrating polymeric network” comprises one or more networks and one or more polymers characterized by some mixing on the molecular level between at least one network and at least one polymer. A mixture of different polymers is a “polymer blend.” A semi-interpenetrating network is technically a polymer blend, but in some cases, the polymers are so entangled that they cannot be readily removed.

The terms “reactive mixture” and “reactive monomer mixture” refer to the mixture of components (both reactive and non-reactive) which are mixed together and when subjected to polymerization conditions form the conventional or silicone hydrogels of the present invention as well as contact lenses made therefrom. The reactive monomer mixture may comprise reactive components such as the monomers, macromers, prepolymers, cross-linkers, and initiators, additives such as wetting agents, release agents, polymers, dyes, light absorbing compounds such as UV absorbers, pigments, dyes and photochromic compounds, any of which may be reactive or non-reactive but are capable of being retained within the resulting biomedical device, as well as pharmaceutical and nutraceutical compounds, and any diluents. It will be appreciated that a wide range of additives may be added based upon the biomedical device which is made and its intended use. Concentrations of components of the reactive mixture are expressed as weight percentages of all components in the reactive mixture, excluding diluent. When diluents are used, their concentrations are expressed as weight percentages based upon the amount of all components in the reactive mixture and the diluent.

“Reactive components” are the components in the reactive mixture which become part of the chemical structure of the polymeric network of the resulting hydrogel by covalent bonding, hydrogen bonding, electrostatic interactions, the formation of interpenetrating polymeric networks, or any other means.

The term “silicone hydrogel contact lens” refers to a hydrogel contact lens comprising at least one silicone containing component. Silicone hydrogel contact lenses generally have increased oxygen permeability compared to conventional hydrogels Silicone hydrogel contact lenses use both their water and polymer content to transmit oxygen to the eye.

The term “multi-functional” refers to a component having two or more polymerizable groups. The term “mono-functional” refers to a component having one polymerizable group.

The terms “halogen” or “halo” indicate fluorine, chlorine, bromine, and iodine.

As used herein, the term “alkyl” refers to an unsubstituted or substituted linear or branched alkyl group containing the indicated number of carbon atoms. If no number is indicated, then alkyl (optionally including any substituents on alkyl) may contain 1 to 16 carbon atoms. Preferably, the alkyl group contains 1 to 10 carbon atoms, alternatively 1 to 7 carbon atoms, or alternatively 1 to 4 carbon atoms. Examples of alkyl include methyl, ethyl, propyl, isopropyl, butyl, iso-, sec- and tert-butyl, pentyl, hexyl, heptyl, 3-ethylbutyl, and the like. Examples of substituents on alkyl include 1, 2, or 3 groups independently selected from hydroxy, amino, amido, oxa, carboxy, alkyl carboxy, carbonyl, alkoxy, amido, carbamate, carbonate, halogen, phenyl, benzyl, thiol, and combinations thereof. “Alkylene” means a divalent alkyl group, such as —CH₂—, —CH₂CH₂—, —CH₂CH₂CH₂—, —CH₂CH(CH₃)CH₂—, and —CH₂CH₂CH₂CH₂—.

“Haloalkyl” refers to an alkyl group as defined above substituted with one or more halogen atoms, where each halogen is independently F, Cl, Br or I. A preferred halogen is F. Preferred haloalkyl groups contain 1-6 carbons, more preferably 1-4 carbons, and still more preferably 1-2 carbons. “Haloalkyl” includes perhaloalkyl groups, such as —CF₃— or —CF₂CF₃—. “Haloalkylene” means a divalent haloalkyl group, such as —CH₂CF₂—.

“Cycloalkyl” refers to an unsubstituted or substituted cyclic hydrocarbon containing the indicated number of ring carbon atoms. If no number is indicated, then cycloalkyl may contain 3 to 12 ring carbon atoms. Preferred are C₃-C₈ cycloalkyl groups, C₃-C₇ cycloalkyl, more preferably C₄-C₇ cycloalkyl, and still more preferably C₅-C₆ cycloalkyl. Examples of cycloalkyl include cyclopropyl, cyclobutyl, cyclopentyl, cyclohexyl, cycloheptyl and cyclooctyl Examples of substituents on cycloalkyl include 1, 2, or 3 groups independently selected from alkyl, hydroxy, amino, amido, oxa, carbonyl, alkoxy, amido, carbamate, carbonate, halo, phenyl, benzyl, and combinations thereof. “Cycloalkylene” means a divalent cycloalkyl group, such as 1,2-cyclohexylene, 1,3-cyclohexylene, or 1,4-cyclohexylene.

“Heterocycloalkyl” refers to a cycloalkyl ring or ring system as defined above in which at least one ring carbon has been replaced with a heteroatom selected from nitrogen, oxygen, and sulfur. The heterocycloalkyl ring is optionally fused to or otherwise attached to other heterocycloalkyl rings and/or non-aromatic hydrocarbon rings and/or phenyl rings. Preferred heterocycloalkyl groups have from 5 to 7 members. More preferred heterocycloalkyl groups have 5 or 6 members. Heterocycloalkylene means a divalent heterocycloalkyl group.

“Aryl” refers to an unsubstituted or substituted aromatic hydrocarbon ring system containing at least one aromatic ring. The aryl group contains the indicated number of ring carbon atoms. If no number is indicated, then aryl may contain 6 to 14 ring carbon atoms. The aromatic ring may optionally be fused or otherwise attached to other aromatic hydrocarbon rings or non-aromatic hydrocarbon rings. Examples of aryl groups include phenyl, naphthyl, and biphenyl. Preferred examples of aryl groups include phenyl. Examples of substituents on aryl include 1, 2, or 3 groups independently selected from alkyl, hydroxy, amino, amido, oxa, carboxy, alkyl carboxy, carbonyl, alkoxy, amido, carbamate, carbonate, halo, phenyl, benzyl, and combinations thereof “Arylene” means a divalent aryl group, for example 1,2-phenylene, 1,3-phenylene, or 1,4-phenylene.

“Heteroaryl” refers to an aryl ring or ring system, as defined above, in which at least one ring carbon atom has been replaced with a heteroatom selected from nitrogen, oxygen, and sulfur. The heteroaryl ring may be fused or otherwise attached to one or more heteroaryl rings, aromatic or nonaromatic hydrocarbon rings or heterocycloalkyl rings. Examples of heteroaryl groups include pyridyl, furyl, and thienyl. “Heteroarylene” means a divalent heteroaryl group.

“Alkoxy” refers to an alkyl group attached to the parent molecular moiety through an oxygen bridge. Examples of alkoxy groups include, for instance, methoxy, ethoxy, propoxy and isopropoxy. “Aryloxy” refers to an aryl group attached to a parent molecular moiety through an oxygen bridge. Examples include phenoxy “Cyclic alkoxy” means a cycloalkyl group attached to the parent moiety through an oxygen bridge.

“Alkylamine” refers to an alkyl group attached to the parent molecular moiety through an —NH bridge. Alkyleneamine means a divalent alkylamine group, such as —CH₂CH₂NH—.

“Ester” refers to a class of organic compounds having the general formula RCOOR′, wherein R and R′ are any organic combining groups. R and R′ may be selected from functional groups comprising alkyls, substituted alkyls, alkylene, haloalkyls, cycloalkyls, heterocyloalkyls, aryls, heteroaryls, alkoxys, cycloalkoxys, alkylamines, siloxanyls, silyls, alkyleneoxys, oxaalkylenes, and the like. Definitions for the above mentioned functional groups are provided herein.

As used herein, “esterification” refers to a reaction producing an ester. The reaction often involves an alcohol and a Bronsted acid (such as a carboxylic acid, sulfuric acid, or phosphoric acid). Furthermore, the term “transesterification” refers to the reaction of an alcohol molecule and a pre-existing ester molecule react to form a new ester. In some aspects, transesterification can be mediated by other compounds, such as carbonyldiimidazole.

“Siloxanyl” refers to a structure having at least one Si—O—Si bond. Thus, for example, siloxanyl group means a group having at least one Si—O—Si group (i.e. a siloxane group), and siloxanyl compound means a compound having at least one Si—O—Si group. “Siloxanyl” encompasses monomeric (e.g., Si—O—Si) as well as oligomeric/polymeric structures (e.g., —[Si—O]ₙ—, where n is 2 or more). Each silicon atom in the siloxanyl group is substituted with independently selected R^{A} groups (where R^{A} is as defined in formula A options (b)-(i)) to complete their valence.

“Silyl” refers to a structure of formula R₃Si— and “siloxy” refers to a structure of formula R₃Si—O—, where each R in silyl or siloxy is independently selected from trimethylsiloxy, C₁-C₈ alkyl (preferably C₁-C₃ alkyl, more preferably ethyl or methyl), and C₃-C₈ cycloalkyl.

“Alkyleneoxy” refers to groups of the general formula -(alkylene-O)ₚ— or —(O-alkylene)ₚ-, wherein alkylene is as defined above, and p is from 1 to 200, or from 1 to 100, or from 1 to 50, or from 1 to 25, or from 1 to 20, or from 1 to 10, wherein each alkylene is independently optionally substituted with one or more groups independently selected from hydroxyl, halo (e.g., fluoro), amino, amido, ether, carbonyl, carboxyl, and combinations thereof. If p is greater than 1, then each alkylene may be the same or different and the alkyleneoxy may be in block or random configuration. When alkyleneoxy forms a terminal group in a molecule, the terminal end of the alkyleneoxy may, for instance, be a hydroxy or alkoxy (e.g., HO—[CH₂CH₂O]ₚ— or CH₃O—[CH₂CH₂O]ₚ—). Examples of alkyleneoxy include polymethyleneoxy, polyethyleneoxy, polypropyleneoxy, polybutyleneoxy, and poly(ethyleneoxy-co-propyleneoxy).

“Oxaalkylene” refers to an alkylene group as defined above where one or more non-adjacent CH₂ groups have been substituted with an oxygen atom, such as —CH₂CH₂OCH(CH₃)CH₂—. “Thiaalkylene” refers to an alkylene group as defined above where one or more non-adjacent CH₂ groups have been substituted with a sulfur atom, such as —CH₂CH₂SCH(CH₃)CH₂—.

The term “linking group” refers to a moiety that links the polymerizable group to the parent molecule. The linking group may be any moiety that does not undesirably interfere with the polymerization of the compound of which it is a part. For instance, the linking group may be a bond, or it may comprise one or more alkylene, haloalkylene, amide, amine, alkyleneamine, carbamate, carboxylate (—CO₂—), disulfide, arylene, heteroarylene, cycloalkylene, heterocycloalkylene, alkyleneoxy, oxaalkylene, thiaalkylene, haloalkyleneoxy (alkyleneoxy substituted with one or more halo groups, e.g., —OCF₂—, —OCF₂CF₂—, —OCF₂CH₂—), siloxanyl, alkylenesiloxanyl, thiol, or combinations thereof. The linking group may optionally be substituted with 1 or more substituent groups. Suitable substituent groups may include those independently selected from alkyl, halo (e.g., fluoro), hydroxyl, HO-alkyleneoxy, CH₃O-alkyleneoxy, siloxanyl, siloxy, siloxy-alkyleneoxy-, siloxy-alkylene-alkyleneoxy-(where more than one alkyleneoxy groups may be present and wherein each methylene in alkylene and alkyleneoxy is independently optionally substituted with hydroxyl), ether, amine, carbonyl, carbamate, and combinations thereof. The linking group may also be substituted with a polymerizable group, such as (meth)acrylate (in addition to the polymerizable group to which the linking group is linked).

Preferred linking groups include C₁-C₈ alkylene (preferably C₂-C₆ alkylene) and C₁-C₈ oxaalkylene (preferably C₂-C₆ oxyalkylene), each of which is optionally substituted with 1 or 2 groups independently selected from hydroxyl and siloxy. Preferred linking groups also include carboxylate, amide, C₁-C₈ alkylene-carboxylate-C₁-C₈ alkylene, or C₁-C₈ alkylene-amide-C₁-C₈ alkylene.

When the linking group is comprised of combinations of moieties as described above (e.g., alkylene and cycloalkylene), the moieties may be present in any order. For instance, if in Formula E below, L is indicated as being -alkylene-cycloalkylene-, then Rg-L may be either Rg-alkylene-cycloalkylene-, or Rg-cycloalkylene-alkylene-. Notwithstanding this, the listing order represents the preferred order in which the moieties appear in the compound starting from the terminal polymerizable group (Rg) to which the linking group is attached. For example, if in Formula E, L and L² are indicated as both being alkylene-cycloalkylene, then Rg-L is preferably Rg-alkylene-cycloalkylene- and -L²-Rg is preferably -cycloalkylene-alkylene-Rg.

As used herein, “oxidation” refers to a chemical process by which an atom of an element gains bonds to more electronegative elements, most commonly oxygen. In this process, the oxidized element increases its oxidation state, which represents the charge of an atom. Oxidation reactions are commonly coupled with “reduction” reactions, wherein the oxidation state of the reduced atom decreases.

As used herein, “anchoring” or “anchoring mechanism” refers to the process by which nanoparticles may become embedded in a colloidal or polymeric matrix. “Anchoring” may occur either chemically via crosslinking of a nanoparticle to members of an exemplary matrix or physically via entanglement of a molecule joined to the surface of a nanoparticle with members of an exemplary matrix.

As used herein, the “visible spectrum” refers to a range of wavelengths within the electromagnetic spectrum, wherein the range spans about 380 nm to 700 nm. The visible spectrum may be broken up into different wavelength regions corresponding to colors including red, orange, yellow, green, blue, indigo, and violet. Certain ranges of wavelengths falling in the visible spectrum have been known to cause damage to human eyes.

As used herein, the “ultraviolet (UV) spectrum” refers to a range of wavelengths within the electromagnetic spectrum, wherein the range spans about 10 nm to 400 nm.

As used herein, “ultraviolet (UV) irradiation” refers to exposure to electromagnetic waves falling in the ultraviolet spectrum of wavelengths, wherein UV irradiation uses selected times and intensity of exposure to achieve its effects, such as curing.

UV irradiation can result in chemical (photo-crosslinking, photo-oxidation, or photochemical reactions) or physical (surface morphology, etc.) changes. Photochemical reactions caused by UV irradiation can be surface-limited or can take place deep inside the bulk (unlike plasma) of a material. Some exemplary sources of UV irradiation may comprise continuous wave (CW) UV-lamps with a moderate light and pulsed lasers.

As used herein, “light absorption” is defined as the phenomenon wherein electrons absorb the energy of incoming light waves (i.e. photons) and change their energy state. In order for this to occur, the incoming light waves must be at or near the energy levels of the electrons. The resultant absorption patterns characteristic to a given material may be displayed using an “absorption spectrum”, wherein an “absorption spectrum” shows the change in absorbance of a sample as a function of the wavelength of incident light and may be measured using a spectrophotometer. Unique to an “absorption spectrum” is an “absorption peak”, wherein the frequency or wavelength of a given sample exhibits the maximum or the highest spectral value of light absorption. With regards to light absorption of wavelengths of light corresponding to the visible spectrum, a material or matter absorbing light waves of certain wavelengths of the visible spectrum may cause an observer to not see these wavelengths in the reflected light.

As used herein, “fluorescence” refers to a type of luminescence that occurs in gas, liquid or solid matter Fluorescence occurs following the absorption of light waves (i.e. photons), which may promote an electron from the ground state promoted to an excited state. In fluorescence, the spin of the electron is still paired with the ground state electron, unlike phosphorescence. As the excited electron returns to the ground state, it emits a photon of lower energy, corresponding to a longer wavelength, than that of the absorbed photon.

As used herein, “phosphorescence” refers to a phenomenon of delayed luminescence that corresponds to the radiative decay of an excited electron from the molecular triplet state. As a general property, phosphorescence represents a challenge of chemical physics due to the spin prohibition of the underlying triplet-singlet photon emission and because its analysis embraces a deep knowledge of electronic molecular structure. Phosphorescence is the simplest physical process which provides an example of spin-forbidden transformation with a characteristic spin selectivity and magnetic field dependence, being the model also for more complicated chemical reactions and for spin catalysis applications. Phosphorescence is commonly viewed as the alternative method of photon emission with regards to fluorescence. Methods exist in the art to increase the amount of fluorescence versus phosphorescence emission, such as the use of heavy metals to increase spin coupling.

As used herein, “Full Width at Half Maximum (FWHM)” refers to a parameter commonly used to describe the width of a portion of a curve or function and may be used in relation to absorbance spectra. It is given by the distance between points on the independent axis of a curve at which the function reaches half its maximum value on the dependent axis.

“Light filtering” may include absorbing, scattering, and/or extinguishing incident light. Light filtering may include the terms “light-blocking material”. Light blocking may refer to a material with the ability to absorb, scatter, and/or extinguish incident light within a given region of the electromagnetic spectrum. Thus, the term “light-blocking material” or “lighting filtering material” encompasses particles that absorb, scatter, and/or extinguish incident light within a given region of the electromagnetic spectrum. The particles can be incorporated in varying quantities within an optically transparent substrate to achieve an optically transparent material which exhibits a desired level of light blocking at one or more wavelengths or a range of wavelengths within the electromagnetic spectrum. The percent blocking at a particular wavelength can be determined from the material's transmission spectrum, where blocking=100−percent transmission (% T).

As used herein, the term “light-blocking profile” or “light-blocking spectrum” refers to the absorption, scattering, and/or extinguishing spectrum of a light-blocking material.

The terms “green-light blocking” or “green-light absorbing” refer to the ability of certain particles to absorb, scatter, and/or extinguish incident light within the green region of the visible spectrum (e.g., between approximately 500 nm and 578 nm). Thus, the terms “green-light blocking” or “green-light absorbing” encompass particles that absorb, scatter, and/or extinguish incident light within the green region of the visible spectrum. The particles can be incorporated in varying quantities within an optically transparent substrate to achieve an optically transparent material which exhibits a desired level of green-light blocking at one or more wavelengths or a range of wavelengths within the green region.

As used herein, the term “organic dye” refers to organic compounds that possess color because they absorb light in the visible spectrum, have at least one chromophore (color-bearing group), have a conjugated system, and exhibit resonance of electrons, which is a stabilizing force in organic compounds (Abrahart, 1977). Organic dyes used in gel-like matrices may exhibit leaching, wherein the dye slowly exits the gel-like matrix. Exemplary organic dyes may include rhodamine-based dyes, such as rhodamine B and rhodamine G6.

“Nanoparticle (NP)” as used herein refers to a particle having at least one dimension that is less than 100 nm. In some cases, nanoparticles can have at least one dimension less than 50 nm. NP's may have a variety of shapes. In some instances, NP's may have a cubic shape, spherical shape, rod shape, bipyramidal shape, an octahedral shape, a decahedral shape, a cuboctahedral shape, a tetrahedral shape, a rhombic dodecahedral shape, a truncated ditetragonal prismatic shape, or a truncated bitetrahedral shape “Plasmonic nanoparticle” as used herein refers to a metal nanoparticle that has unique optical properties due to local surface plasmon resonance that allow them to interact with light waves. These properties are tunable by changing the shape, size, composition or medium surrounding the nanoparticle's surface. It will be appreciated that the term includes all plasmonic nanoparticles of various shapes that gives rise to a surface plasmon absorption and scattering spectrum

As used herein, a “shape-directing agent” is a surfactant or reagent used to grow nanoparticles into specific morphologies. By utilizing specific shape-directing agents, specific morphologies may be selected, allowing for the optical properties of the resultant nanoparticles to be tuned Exemplary shape-directing agents may include, but are not limited to, AgNO₃, CTAB, CTAC, and other such agents known in the art.

As used herein, “anisotropic” describes a material wherein a given property of said material depends on the direction in which it is measured. Moreover, something that is “anisotropic” changes in size or in its physical properties according to the direction in which it is measured. Examples of anisotropic materials may comprise graphite, carbon fiber, nanoparticles, etc.

As used herein, “isotropic” describes a material wherein a given property of said material does not depend on the direction in which it is measured. Moreover, something that is “isotropic” remains constant in size or in its physical properties according to the direction in which it is measured.

As used herein, “surface energy” may refer to the excess energy (i.e., the difference in the energy between a nanoparticle and the same number of atoms in an infinitely extended solid). More broadly, the surface energy of a particle may define its stability given its morphology and directly relates to the thermodynamics of a given nanoparticle.

As used herein, “surface plasmon resonance (SPR)” refers to a phenomenon wherein the conduction electrons in the surface layer of a metal may become excited by photons of incident light with a certain angle of incidence, causing the excited conduction electrons to then propagate parallel to the metal surface in resonant oscillations (Zeng et al., 2017). With a constant light source wavelength and a thin metal surface layer, the certain angle that triggers SPR is dependent on the refractive index of the material near the metal surface. As used herein, “localized surface plasmon resonance (LSPR)” refers to an optical phenomena generated by light when it interacts with conductive nanoparticles that are smaller than the incident wavelength. As in surface plasmon resonance, the electric field of incident light can be deposited to collectively excite electrons of a conduction band, with the result being coherent localized plasmon oscillations with a resonant frequency that strongly depends on the composition, size, geometry, dielectric environment and separation distance of NP's.

As used herein, a “localized surface plasmon resonance (LSPR) peak” refers to the frequency or wavelength of incident light that exhibits the maximum or the highest spectral value of localized surface plasmon resonance With regards to LSPR peaks, there are frequently two distinct peaks observed: a “longitudinal peak” and a “transverse peak”. The former relates to the shape of the nanoparticle utilized, whereas the latter is a result of the innate properties of the material used. Gold, for instance, has an inherent transverse peak around 530 nm, though the longitudinal peak of a gold NP can be tuned by adjusting its morphology.

As used herein, “plasmonic light blocker” refers to a material with the ability to absorb, scatter, and/or extinguish incident light within a given region of the electromagnetic spectrum due to surface plasmonic resonance (SPR) or localized surface plasmonic resonance (LSPR), wherein the wavelength or range of wavelengths blocked correspond to the wavelength of incident light that induces the SPR or LSPR. Thus, the term “plasmonic light blocker” encompasses particles that absorb, scatter, and/or extinguish incident light within a given region of the electromagnetic spectrum due to SPR or LSPR. The particles can be incorporated in varying quantities within an optically transparent substrate to achieve an optically transparent material which exhibits a desired level of light blocking at one or more wavelengths or a range of wavelengths within the electromagnetic spectrum. The percent blocking at a particular wavelength can be determined from the material's transmission spectrum, where blocking=100−percent transmission (% T).

“Tuning” as used herein refers to changing the size, shape, surface chemistry or aggregation state of a nanoparticle in order to optimize the optical and electronic properties of the nanoparticle to a particular application. The plasmonic peak can be tuned to any wavelength by a suitable design of the nanoparticles as discussed in U.S. Pat. No. 9,005,890, herein incorporated in its entirety by reference.

As used herein, “ligand” refers to an ion or neutral molecule that bonds to a central metal atom or ion. Exemplary ligands may comprise PVP, PVA, DSDMA, and other molecules capable of bonding to a central metal atom Metal atoms may comprise a variety of metals including, but not limited to, noble metals such as gold. Ligands have at least one donor with an electron pair used to form covalent bonds with the metal central atom.

As used herein, an “intermediate ligand” refers to a ligand temporarily conjugated to a metal atom that is further exchanged to allow the conjugation of an alternate ligand.

Unless otherwise indicated, numeric ranges, for instance as in “from 2 to 10,” are inclusive of the numbers defining the range (e.g., 2 and 10).

The term “biocompatible”, as used herein is intended to describe materials that do not elicit a substantial detrimental response in vivo. In certain embodiments, the materials are “biocompatible” if they are not toxic to cells. In certain embodiments, materials are “biocompatible” if their addition to cells in vitro results in less than or equal to 20% cell death, and/or their administration in vivo does not induce inflammation or other such adverse effects.

The term “static concentration”, as used herein, refers to a concentration of the trigger, which may vary from about 1% to about 10% For example, the static concentration may vary by +/−10%, +/−5%, +/−2%, or +/−1%.

Unless otherwise indicated, ratios, percentages, parts, and the like are by weight.

Unless otherwise indicated, numeric ranges, for instance as in “from 2 to 10,” are inclusive of the numbers defining the range (e.g., 2 and 10)

Devices

The resulting optically transparent materials can be used to form a variety of different articles, including optical lenses (e.g., eyeglass lenses, camera lenses, contact lenses, etc.), ophthalmic devices (e.g., contact lenses, corneal onlays, corneal inlays, intraocular lenses, overlay lenses, etc.), screen covers (e.g., a transparent sheet configured to cover a computer monitor, tablet screen, or cell phone screen), and housings for electronic devices having LED displays. Accordingly, also provided are optical lenses (e.g., eyeglass lenses, camera lenses, contact lenses, etc.), ophthalmic devices (e.g., contact lenses, corneal onlays, corneal inlays, intraocular lenses, overlay lenses, etc.), screen covers (e.g., a transparent sheet configured to cover a computer monitor, tablet screen, or cell phone screen), and housings for electronic devices having LED displays which are formed at whole or in part from the optically transparent materials described herein.

A variety of ophthalmic devices containing the nanoparticles described herein may be prepared, including hard contact lenses, soft contact lenses, corneal onlays, corneal inlays, intraocular lenses, or overlay lenses. Preferably, the ophthalmic device is a soft contact lens, which may be made from conventional or silicone hydrogel formulations.

Ophthalmic devices may be prepared by polymerizing a reactive mixture containing a population of the nanoparticles described herein, one or more monomers suitable for making the desired ophthalmic device, and optional components. In some cases, the reactive mixture may include, in addition to a population of the nanoparticles described above, one or more of: hydrophilic components, hydrophobic components, silicone-containing components, wetting agents such as polyamides, crosslinking agents, and further components such as diluents and initiators.

Silicone-Containing Components

Silicone-containing components suitable for use comprise one or more polymerizable compounds, where each compound independently comprises at least one polymerizable group, at least one siloxane group, and one or more linking groups connecting the polymerizable group(s) to the siloxane group(s). The silicone-containing components may, for instance, contain from 1 to 220 siloxane repeat units, such as the groups defined below. The silicone-containing component may also contain at least one fluorine atom.

The silicone-containing component may comprise: one or more polymerizable groups as defined above; one or more optionally repeating siloxane units; and one or more linking groups connecting the polymerizable groups to the siloxane units. The silicone-containing component may comprise: one or more polymerizable groups that are independently a (meth)acrylate, a styryl, a vinyl ether, a (meth)acrylamide, an N-vinyl lactam, an N-vinylamide, an O-vinylcarbamate, an O-vinylcarbonate, a vinyl group, or mixtures of the foregoing, one or more optionally repeating siloxane units; and one or more linking groups connecting the polymerizable groups to the siloxane units.

The silicone-containing component may comprise: one or more polymerizable groups that are independently a (meth)acrylate, a (meth)acrylamide, an N-vinyl lactam, an N-vinylamide, a styryl, or mixtures of the foregoing, one or more optionally repeating siloxane units, and one or more linking groups connecting the polymerizable groups to the siloxane units.

The silicone-containing component may comprise: one or more polymerizable groups that are independently a (meth)acrylate, a (meth)acrylamide, or mixtures of the foregoing, one or more optionally repeating siloxane units; and one or more linking groups connecting the polymerizable groups to the siloxane units.

Formula A. The silicone-containing component may comprise one or more polymerizable compounds of Formula A:

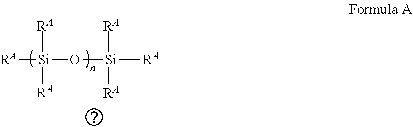

wherein:
   at least one R^{A} is a group of formula R_{g}-L- wherein R_{g} is a polymerizable group and L is a linking group, and the remaining R^{A} are each independently:
(a) R_{g}-L-,
(b) C₁-C₁₆ alkyl optionally substituted with one or more hydroxy, amino, amido, oxa, carboxy, alkyl carboxy, carbonyl, alkoxy, amido, carbamate, carbonate, halo, phenyl, benzyl, or combinations thereof,
(c) C₃-C₁₂ cycloalkyl optionally substituted with one or more alkyl, hydroxy, amino, amido, oxa, carbonyl, alkoxy, amido, carbamate, carbonate, halo, phenyl, benzyl, or combinations thereof,
(d) a C₆-C₁₄ aryl group optionally substituted with one or more alkyl, hydroxy, amino, amido, oxa, carboxy, alkyl carboxy, carbonyl, alkoxy, amido, carbamate, carbonate, halo, phenyl, benzyl, or combinations thereof,
(e) halo,
(f) alkoxy, cyclic alkoxy, or aryloxy,
(g) siloxy,
(h) alkyleneoxy-alkyl or alkoxy-alkyleneoxy-alkyl, such as polyethyleneoxyalkyl, polypropyleneoxyalkyl, or poly(ethyleneoxy-co-propyleneoxyalkyl), or
(i) a monovalent siloxane chain comprising from 1 to 100 siloxane repeat units optionally substituted with alkyl, alkoxy, hydroxy, amino, oxa, carboxy, alkyl carboxy, alkoxy, amido, carbamate, halo or combinations thereof, and
   n is from 0 to 500 or from 0 to 200, or from 0 to 100, or from 0 to 20, where it is understood that when n is other than 0, n is a distribution having a mode equal to a stated value. When n is 2 or more, the SiO units may carry the same or different R^{A} substituents and if different R^{A} substituents are present, the n groups may be in random or block configuration.

In Formula A, three R^{A} may each comprise a polymerizable group, alternatively two R^{A} may each comprise a polymerizable group, or alternatively one R^{A} may comprise a polymerizable group.

Formula B. The silicone-containing component of formula A may be a mono-functional polymerizable compound of formula B:

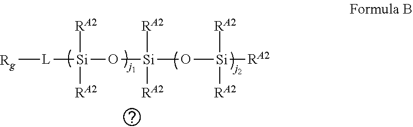

wherein:
   Rg is a polymerizable group,
   L is a linking group;
   j1 and j2 are each independently whole numbers from 0 to 220, provided that the sum of j1 and j2 is from 1 to 220,
   R^{A1}, R^{A2}, R^{A3}, R^{A4}, R^{A5}, and R^{A7} are independently at each occurrence C₁-C₆ alkyl, C₃-C₁₂ cycloalkyl, C₁-C₆ alkoxy, C₄-C₁₂ cyclic alkoxy, alkoxy-alkyleneoxy-alkyl, aryl (e.g., phenyl), aryl-alkyl (e.g., benzyl), haloalkyl (e.g., partially or fully fluorinated alkyl), siloxy, fluoro, or combinations thereof, wherein each alkyl in the foregoing groups is optionally substituted with one or more hydroxy, amino, amido, oxa, carboxy, alkyl carboxy, carbonyl, alkoxy, carbamate, carbonate, halo, phenyl, or benzyl, each cycloalkyl is optionally substituted with one or more alkyl, hydroxy, amino, amido, oxa, carbonyl, alkoxy, carbamate, carbonate, halo, phenyl, or benzyl and each aryl is optionally substituted with one or more alkyl, hydroxy, amino, amido, oxa, carboxy, alkyl carboxy, carbonyl, alkoxy, carbamate, carbonate, halo, phenyl, or benzyl; and
   R^{A6} is siloxy, C₁-C₈ alkyl (e.g., C₁-C₄ alkyl, or butyl, or methyl), or aryl (e.g., phenyl), wherein alkyl and aryl may optionally be substituted with one or more fluorine atoms.

Formula B-1. Compounds of formula B may include compounds of formula B-1, which are compounds of formula B wherein j1 is zero and j2 is from 1 to 220, or j2 is from 1 to 100, or j2 is from 1 to 50, or j2 is from 1 to 20, or j2 is from 1 to 5, or j2 is 1.

B-2. Compounds of formula B may include compounds of formula B-2, which are compounds of formula B wherein j1 and j2 are independently from 4 to 100, or from 4 to 20, or from 4 to 10, or from 24 to 100, or from 10 to 100.

B-3. Compounds of formulae B, B-1, and B-2 may include compounds of formula B-3, which are compounds of formula B, B-1, or B-2 wherein R^{A1}, R^{A2}, R^{A3}, and R^{A4} are independently at each occurrence C₁-C₆alkyl or siloxy Preferred alkyl are C₁-C₃ alkyl, or more preferably, methyl. Preferred siloxy is trimethylsiloxy.

B-4. Compounds of formulae B, B-1, B-2, and B-3 may include compounds of formula B-4, which are compounds of formula B, B-1, B-2, or B-3 wherein R^{A5} and R^{A7} are independently alkoxy-alkyleneoxy-alkyl, preferably they are independently a methoxy capped polyethyleneoxyalkyl of formula CH₃O—[CH₂CH₂O]ₚ—CH₂CH₂CH₂, wherein p is a whole number from 1 to 50.

B-5. Compounds of formulae B, B-1, B-2, and B-3 may include compounds of formula B-5, which are compounds of formula B, B-1, B-2, or B-3 wherein R^{A5} and R^{A7} are independently siloxy, such as trimethylsiloxy.

B-6. Compounds of formulae B, B-1, B-2, and B-3 may include compounds of formula B-6, which are compounds of formula B, B-1, B-2, or B-3 wherein R_{A5} and R^{A7} are independently C₁-C₆ alkyl, alternatively C₁-C₄ alkyl, or alternatively, butyl or methyl.

B-7. Compounds of formulae B, B-1, B-2, B-3, B-4, B-5, and B-6 may include compounds of formula B-7, which are compounds of formula B, B-1, B-2, B-3, B-4, B-5, or B-6 wherein R^{A6} is C₁-C₈ alkyl, preferably C₁-C₆ alkyl, more preferably C₁-C₄alkyl (for example methyl, ethyl, n-propyl, or n-butyl). More preferably R^{A6} is n-butyl.

B-8. Compounds of formulae B, B-1, B-2, B-3, B-4, B-5, B-6, and B-7, may include compounds of formula B-8, which are compounds of formula B, B-1, B-2, B-3, B-4, B-5, B-6, or B-7 wherein Rg comprises styryl, vinyl carbonate, vinyl ether, vinyl carbamate, N-vinyl lactam, N-vinylamide, (meth)acrylate, or (meth)acrylamide Preferably, Rg comprises (meth)acrylate, (meth)acrylamide, or styryl. More preferably, Rg comprises (meth)acrylate or (meth)acrylamide.

When Rg is (meth)acrylamide, the nitrogen group may be substituted with R^{A9}, wherein R^{A9} is H, C₁-C₈ alkyl (preferably C₁-C₄ alkyl, such as n-butyl, n-propyl, methyl or ethyl), or C₃-C₈ cycloalkyl (preferably C₅-C₆ cycloalkyl), wherein alkyl and cycloalkyl are optionally substituted with one or more groups independently selected from hydroxyl, amide, ether, silyl (e.g., trimethylsilyl), siloxy (e.g., trimethylsiloxy), alkyl-siloxanyl (where alkyl is itself optionally substituted with fluoro), aryl-siloxanyl (where aryl is itself optionally substituted with fluoro), and silyl-oxaalkylene- (where the oxaalkylene is itself optionally substituted with hydroxyl).

B-9. Compounds of formulae B, B-1, B-2, B-3, B-4, B-5, B-6, B-7, and B-8 may include compounds of formula B-9, which are compounds of formula B, B-1, B-2, B-3, B-4, B-5, B-6, B-7, or B-8 wherein the linking group comprises alkylene (preferably C₁-C₄ alkylene), cycloalkylene (preferably C₅-C₆ cycloalkylene), alkyleneoxy (preferably ethyleneoxy), haloalkyleneoxy (preferably haloethyleneoxy), amide, oxaalkylene (preferably containing 3 to 6 carbon atoms), siloxanyl, alkylenesiloxanyl, carbamate, alkyleneamine (preferably C₁-C₆ alkyleneamine), or combinations of two or more thereof, wherein the linking group is optionally substituted with one or more substituents independently selected from alkyl, hydroxyl, ether, amine, carbonyl, siloxy, and carbamate.

B-10. Compounds of formulae B, B-1, B-2, B-3, B-4, B-5, B-6, B-7, B-8, and B-9 may include compounds of formula B-10, which are compounds of formula B, B-1, B-2, B-3, B-4, B-5, B-6, B-7, B-8, or B-9 wherein the linking group is alkylene-siloxanyl-alkylene-alkyleneoxy-, or alkylene-siloxanyl-alkylene-[alkyleneoxy-alkylene-siloxanyl]_{q}-alkyleneoxy-, where q is from 1 to 50.

B-11. Compounds of formulae B, B-1, B-2, B-3, B-4, B-5, B-6, B-7, B-8, and B-9 may include compounds of formula B-11, which are compounds of formula B, B-1, B-2, B-3, B-4, B-5, B-6, B-7, B-8, or B-9 wherein the linking group is C₁-C₆ alkylene, preferably C₁-C₃ alkylene, more preferably n-propylene.

B-12. Compounds of formulae B, B-1, B-2, B-3, B-4, B-5, B-6, B-7, B-8, and B-9 may include compounds of formula B-12, which are compounds of formula B, B-1, B-2, B-3, B-4, B-5, B-6, B-7, B-8, or B-9 wherein the linking group is alkylene-carbamate-oxaalkylene Preferably, the linking group is CH₂CH₂N(H)—C(—O)—O—CH₂CH₂O—CH₂CH₂CH₂.

B-13. Compounds of formulae B, B-1, B-2, B-3, B-4, B-5, B-6, B-7, B-8, and B-9 may include compounds of formula B-13, which are compounds of formula B, B-1, B-2, B-3, B-4, B-5, B-6, B-7, B-8, or B-9 wherein the linking group is oxaalkylene. Preferably, the linking group is CH₂CH₂—O—CH₂CH₂CH₂.

B-14. Compounds of formulae B, B-1, B-2, B-3, B-4, B-5, B-6, B-7, B-8, and B-9 may include compounds of formula B-14, which are compounds of formula B, B-1, B-2, B-3, B-4, B-5, B-6, B-7, B-8, or B-9 wherein the linking group is alkylene-[siloxanyl-alkylene]_{q}-, where q is from 1 to 50. An example of such a linking group is: —(CH₂)₃—[Si(CH₃)₂—O—Si(CH₃)₂—(CH₂)₂]_{q}—.

B-15. Compounds of formulae B, B-1, B-2, B-3, B-4, B-5, B-6, B-7, B-8, and B-9 may include compounds of formula B-15, which are compounds of formula B, B-1, B-2, B-3, B-4, B-5, B-6, B-7, B-8, or B-9 wherein the linking group is alkyleneoxy-carbamate-alkylene-cycloalkylene-carbamate-oxaalkylene, wherein cycloalkylene is optionally substituted with or 1, 2, or 3 independently selected alkyl groups (preferably C₁-C₃ alkyl, more preferably methyl). An example of such a linking group is —[OCH₂CH₂]_{q}—OC(—O)—NH—CH₂-[1,3-cyclohexylene]-NHC(—O)O—CH₂CH₂—O—CH₂CH₂—, wherein the cyclohexylene is substituted at the 1 and 5 positions with 3 methyl groups.

B-16. Compounds of formulae B, B-1, B-2, B-3, B-4, B-5, B-6, B-7, B-8, and B-9 may include compounds of formula B-16, which are compounds of formula B, B-1, B-2, B-3, B-4, B-5, B-6, B-7, B-8, or B-9 wherein Rg comprises styryl and the linking group is alkyleneoxy wherein each alkylene in alkyleneoxy is independently optionally substituted with hydroxyl. An example of such a linking group is —O—(CH₂)₃—. Another example of such a linking group is —O—CH₂CH(OH)CH₂—O—(CH₂)₃—.

B-17. Compounds of formulae B, B-1, B-2, B-3, B-4, B-5, B-6, B-7, B-8, and B-9 may include compounds of formula B-17, which are compounds of formula B, B-1, B-2, B-3, B-4, B-5, B-6, B-7, B-8, or B-9 wherein Rg comprises styryl and the linking group is alkyleneamine. An example of such a linking group is —NH—(CH₂)₃—.

B-18. Compounds of formulae B, B-1, B-2, B-3, B-4, B-5, B-6, B-7, B-8, and B-9 may include compounds of formula B-18, which are compounds of formula B, B-1, B-2, B-3, B-4, B-5, B-6, B-7, B-8, or B-9 wherein the linking group is oxaalkylene optionally substituted with hydroxyl, siloxy, or silyl-alkyleneoxy (where the alkyleneoxy is itself optionally substituted with hydroxyl). An example of such a linking group is —CH₂CH(G)CH₂—O—(CH₂)₃—, wherein G is hydroxyl. In another example, G is R₃SiO— wherein two R groups are trimethylsiloxy and the third is C₁-C₈ alkyl (preferably C₁-C₃ alkyl, more preferably methyl) or the third is C₃-C₈ cycloalkyl. In a further example, G is R₃Si—(CH₂)₃—O—CH₂CH(OH)CH₂—O—, wherein two R groups are trimethylsiloxy and the third is C₁-C₈ alkyl (preferably (C₁-C₃ alkyl, more preferably methyl) or C₃-C₈ cycloalkyl. In a still further example, G is a polymerizable group, such as (meth)acrylate. Such compounds may function as crosslinkers.

B-19. Compounds of formulae B, B-1, B-2, B-3, B-4, B-5, B-6, B-7, B-8, and B-9 may include compounds of formula B-19, which are compounds of formula B, B-1, B-2, B-3, B-4, B-5, B-6, B-7, B-8, or B-9 wherein Rg comprises styryl and the linking group is amine-oxaalkylene optionally substituted with hydroxyl. An example of such a linking group is —NH—CH₂CH(OH)CH₂—O—(CH₂)₃—.

B-20. Compounds of formulae B, B-1, B-2, B-3, B-4, B-5, B-6, B-7, B-8, and B-9 may include compounds of formula B-20, which are compounds of formula B, B-1, B-2, B-3, B-4, B-5, B-6, B-7, B-8, or B-9 wherein Rg comprises styryl and the linking group is alkyleneoxy-carbamate-oxaalkylene. An example of such a linking group is —O—(CH₂)₂—N(H)C(—O)O—(CH₂)₂—O—(CH₂)₃—.

B-21. Compounds of formulae B, B-1, B-2, B-3, B-4, B-5, B-6, B-7, B-8, and B-9 may include compounds of formula B-21, which are compounds of formula B, B-1, B-2, B-3, B-4, B-5, B-6, B-7, B-8, or B-9 wherein the linking group is alkylene-carbamate-oxaalkylene. An example of such a linking group is —(CH₂)₂—N(H)C(—O)O—(CH₂)₂—O—(CH₂)₃—.

Formula C. Silicone-containing components of formulae A, B, B-1, B-2, B-3, B-4, B-5, B-6, B-7, B-8, B-9, B-10, B-11, B-12, B-13, B-14, B-15, B-18, and B-21 may include compounds of formula C, which are compounds of formula A, B, B-1, B-2, B-3, B-4, B-5, B-6, B-7, B-8, B-9, B-10, B-11, B-12, B-13, B-14, B-15, B-18, or B-21 having the structure:

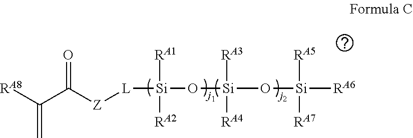

wherein
   R^{A8} is hydrogen or methyl;
   Z is O, S, or N(R^{A9}); and
   L, j1, j2, R^{A1}, R^{A2}, R^{A3}, R^{A4}, R^{A5}, R^{A6}, R^{A7}, and R^{A9} are as defined in formula B or its various sub-formulae (e.g., B-1, 1-2, etc.).

C-1. Compounds of formula C may include (meth)acrylates of formula C-1, which are compounds of formula C wherein Z is O.

C-2. Compounds of formula C may include (meth)acrylamides of formula C-2, which are compounds of formula C wherein Z is N(R^{A9}), and R^{A9} is H.

C-3. Compounds of formulae C may include (meth)acrylamides of formula C-3, which are compounds of formula C wherein Z is N(R^{A9}), and R^{A9} is C₁-C₈ alkyl that is unsubstituted or is optionally substituted as indicated above Examples of R^{A9} include CH₃, —CH₂CH(OH)CH₂(OH), —(CH₂)₃-siloxanyl, —(CH₂)₃—SiR₃, and —CH₂CH(OH)CH₂—O—(CH₂)₃—SiR₃ where each R in the foregoing groups is independently selected from trimethylsiloxy, C₁-C₈ alkyl (preferably C₁-C₃ alkyl, more preferably methyl), and C₃-C₈ cycloalkyl. Further examples of R^{A9} include: —(CH₂)₃—Si(Me)(SiMe₃)₂, and —(CH₂)₃—Si(Me₂)-[O—SiMe₂]₁₋₁₀-CH₃.

Formula D. Compounds of formula C may include compounds of formula D:

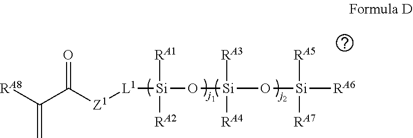

wherein
   R^{A8} is hydrogen or methyl,
   Z¹ is O or N(R^{A9});
   L¹ is alkylene containing 1 to 8 carbon atoms, or oxaalkylene containing 3 to 10 carbon atoms, wherein L¹ is optionally substituted with hydroxyl, and
   j2, R_{A3}, R^{A4}, R^{A5}, R^{A6}, R^{A7}, and R^{A9} are as defined above in formula B or its various sub-formulae (e.g., B-1, B-2, etc.).

D-1. Compounds of formula D may include compounds of formula D-1, which are compounds of formula D wherein L¹ is C₂-C₅ alkylene optionally substituted with hydroxyl. Preferably L¹ is n-propylene optionally substituted with hydroxyl.

D-2 Compounds of formula D may include compounds of formula D-2, which are compounds of formula D wherein L¹ is oxaalkylene containing 4 to 8 carbon atoms optionally substituted with hydroxyl. Preferably L¹ is oxaalkylene containing five or six carbon atoms optionally substituted with hydroxyl Examples include —(CH₂)₂—O—(CH₂)₃—, and —CH₂CH(OH)CH₂—O—(CH₂)₃—.

D-3 Compounds of formulae D, D-1, and D-2 may include compounds of formula D-3, which are compounds of formula D, D-1, or D-2 wherein Z¹ is O.

D-4. Compounds of formulae D, D-1, and D-2 may include compounds of formula D-4, which are compounds of formula D, D-1, or D-2 wherein Z¹ is N(R^{A9}), and R^{A9} is H.

D-5. Compounds of formulae D, D-1, and D-2 may include compounds of formula D-5, which are compounds of formula D, D-1, or D-2 wherein Z¹ is N(R^{A9}), and R^{A9} is C₁-C₄ alkyl optionally substituted with 1 or 2 substituents selected from hydroxyl, siloxy, and C₁-C₆ alkyl-siloxanyl-.

D-6. Compounds of formulae D, D-1, D-2, D-3, D-4, and D-5 may include compounds of formula D-6, which are compounds of formula D, D-1, D-2, D-3, D-4, or D-5 wherein j2 is 1.

D-7 Compounds of formulae D, D-1, D-2, D-3, D-4, and D-5 may include compounds of formula D-7, which are compounds of formula D, D-1, D-2, D-3, D-4, or D-5 wherein j2 is from 2 to 220, or from 2 to 100, or from 10 to 100, or from 24 to 100, or from 4 to 20, or from 4 to 10.

D-8. Compounds of formulae D, D-1, D-2, D-3, D-4, D-5, D-6, and D-7 may include compounds of formula D-8, which are compounds of formula D, D-1, D-2, D-3, D-4, D-5, D-6, or D-7 wherein R^{A3}, R^{A4}, R^{A5}, R^{A6}, and R^{A7} are independently C₁-C₆ alkyl or siloxy. Preferably R^{A3}, R^{A4}, R^{A5}, R^{A6}, and R^{A7} are independently selected from methyl, ethyl, n-propyl, n-butyl, and trimethylsiloxy. More preferably, R^{A3}, R^{A4}, R^{A5}, R^{A6}, and R^{A7} are independently selected from methyl, n-butyl, and trimethylsiloxy.

D-9 Compounds of formulae D, D-1, D-2, D-3, D-4, D-5, D-6, and D-7 may include compounds of formula D-9, which are compounds of formula D, D-1, D-2, D-3, D-4, D-5, D-6, or D-7 wherein R^{A3} and R^{A4} are independently C₁-C₆ alkyl (e.g., methyl or ethyl) or siloxy (e.g., trimethylsiloxy), and R^{A5}, R^{A6}, and R^{A7} are independently C₁-C₆ alkyl (e.g., methyl, ethyl, n-propyl, or n-butyl).

Formula E. The silicone-containing component may comprise a multi-functional silicone-containing component Thus, for example, the silicone-containing component of formula A may comprise a bifunctional material of formula E:

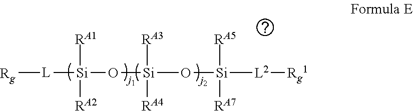

wherein
   Rg, L, j1, j2, R^{A1}, R^{A2}, R^{A3}, R^{A4}, R^{A5}, and R^{A7} are as defined above for formula B or its various sub-formulae (e.g., B-1, B-2, etc.);
   L² is a linking group; and
   Rg¹ is a polymerizable group.

E-1. Compounds of formula E may include compounds of formula E-1, which are compounds of formula F wherein Rg and Rg¹ are each a vinyl carbonate of structure CH₂—CH—O—C(—O)—O— or structure CH₂—C(CH₃)—O—C(—O)—O—.

E-2. Compounds of formula E may include compounds of formula E-2, which are compounds of formula E wherein Rg and Rg¹ are each (meth)acrylate.

E-3. Compounds of formula E may include compounds of formula E-3, which are compounds of formula E wherein Rg and Rg¹ are each (meth)acrylamide, wherein the nitrogen group may be substituted with R^{A9} (wherein R^{A9} is as defined above).

E-4. Suitable compounds of formulae E, E-1, E-2, and E-3 include compounds of formula E-4, which are compounds of formula E, E-1, E-2, or E-3 wherein j is zero and j2 is from 1 to 220, or j2 is from 1 to 100, or j2 is from 1 to 50, or j2 is from 1 to 20.

E-5. Suitable compounds of formulae E, E-1, E-2, and E-3 include compounds of formula E-5, which are compounds of formula E, E-1, E-2, or E-3, wherein j1 and j2 are independently from 4 to 100.

E-6. Suitable compounds of formulae E, E-1, E-2, E-3, E-4, and E-5 include compounds of formula E-6, which are compounds of formula E, E-1, E-2, E-3, E-4, or E-5 wherein R^{A1}, R^{A2}, R^{A3}, R^{A4}, and R^{A5} are independently at each occurrence C₁-C₆ alkyl, preferably they are independently C₁-C₃ alkyl, or preferably, each is methyl.

E-7. Suitable compounds of formulae E, E-1, E-2, E-3, E-4, E-5, and E-6 include compounds of formula E-7, which are compounds of formula E, E-1, E-2, E-3, E-4, E-5, or E-6 wherein R^{A7} is alkoxy-alkyleneoxy-alkyl, preferably it is a methoxy capped polyethyleneoxyalkyl of formula CH₃—O—[CH₂CH₂O]ₚ—CH₂CH₂CH₂, wherein p is a whole number from 1 to 50, or from 1 to 30, or from 1 to 10, or from 6 to 10.

E-8. Suitable compounds of formulae E, E-1, E-2, E-3, E-4, E-5, E-6, and E-7 include compounds of formula E-8, which are compounds of formula E, E-1, E-2, E-3, E-4, E-5, E-6, or E-7 wherein L comprises alkylene, carbamate, siloxanyl, cycloalkylene, amide, haloalkyleneoxy, oxaalkylene, or combinations of two or more thereof, wherein the linking group is optionally substituted with one or more substituents independently selected from alkyl, hydroxyl, ether, amine, carbonyl, and carbamate.

E-9. Suitable compounds of formulae E, E-1, E-2, E-3, E-4, E-5, E-6, E-7, and E-8 include compounds of formula E-9, which are compounds of formula E, E-1, E-2, F-3, E-4, E-5, E-6, E-7, or E-8 wherein L² comprises alkylene, carbamate, siloxanyl, cycloalkylene, amide, haloalkyleneoxy, oxaalkylene, or combinations of two or more thereof, wherein the linking group is optionally substituted with one or more substituents independently selected from alkyl, hydroxyl, ether, amine, carbonyl, and carbamate.

Examples of silicone-containing components suitable for use in the invention include, but are not limited to, compounds listed in the table below. Where the compounds in the table below include polysiloxane groups, the number of Si repeat units in such compounds, unless otherwise indicated, is preferably from 3 to 100, more preferably from 3 to 40, or still more preferably from 3 to 20.
1 mono-methacryloxypropyl terminated mono-n-butyl terminated polydimethylsiloxanes (mPDMS) (preferably containing from 3 to 15 SiO repeating units)
2 mono-acryloxypropyl terminated mono-n-butyl terminated polydimethylsiloxane
3 mono(meth)acryloxypropyl terminated mono-n-methyl terminated polydimethylsiloxane
4 mono(meth)acryloxypropyl terminated mono-n-butyl terminated polydiethylsiloxane
5 mono(meth)acryloxypropyl terminated mono-n-methyl terminated polydiethylsiloxane
6 mono(meth)acrylamidoalkylpolydialkylsiloxanes
7 mono(meth)acryloxyalkyl terminated mono-alkyl polydiarylsiloxanes
8 3-methacryloxypropyltris(trimethylsiloxy)silane (TRIS)
9 3-methacryloxypropylbis(trimethylsiloxy)methylsilane
10 3-methacryloxypropylpentamethyl disiloxane
11 mono(meth)acrylamidoalkylpolydialkylsiloxanes
12 mono(meth)acrylamidoalkyl polydimethylsiloxanes
13 N-(2,3-dihydroxypropane)-N′-(propyl tetra(dimethylsiloxy) dimethylbutylsilane)acrylamide
14 N-[3-tris(trimethylsiloxy)silyl]-propyl acrylamide (TRIS-Am)
15 2-hydroxy-3-[3-methyl-3,3-di(trimethylsiloxy)silylpropoxy]-propyl methacrylate (SiMAA)
16 2-hydroxy-3-methacryloxypropyloxypropyl-tris(trimethylsiloxy)silane mono-(2-hydroxy-3-methacryloxypropyl)-propyl ether terminated mono-n-butyl
17 terminated polydimethylsiloxanes (OH-mPDMS) (containing from 4 to 30, or from 10 to 20, or from 4 to 8 SiO repeat units)

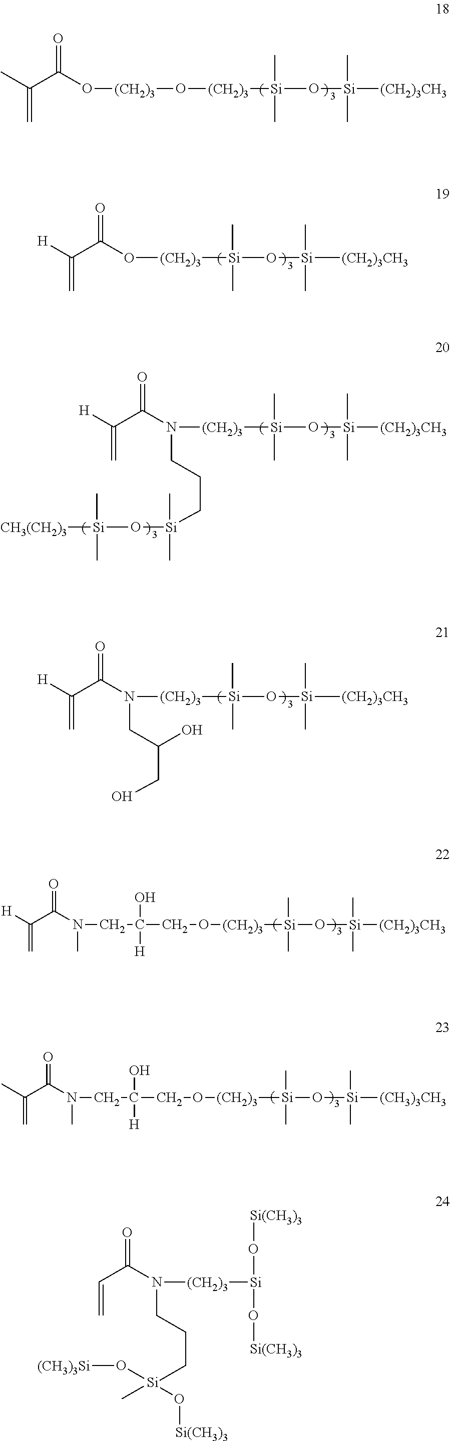

Additional non-limiting examples of suitable silicone-containing components are listed in the table below. Unless otherwise indicated, j2 where applicable is preferably from 1 to 100, more preferably from 3 to 40, or still more preferably from 3 to 15. In compounds containing j1 and j2, the sum of j1 and j2 is preferably from 2 to 100, more preferably from 3 to 40, or still more preferably from 3 to 15.

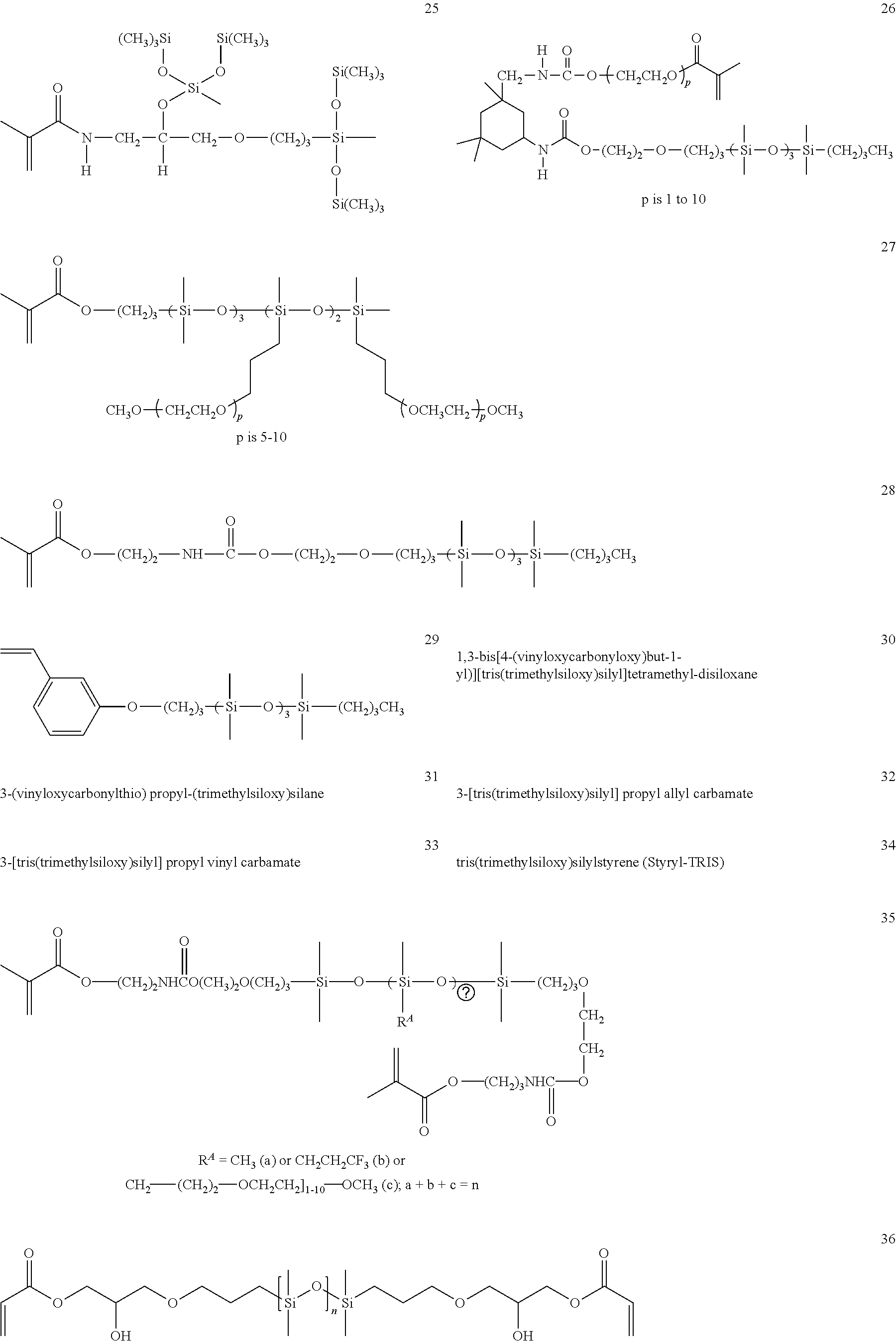

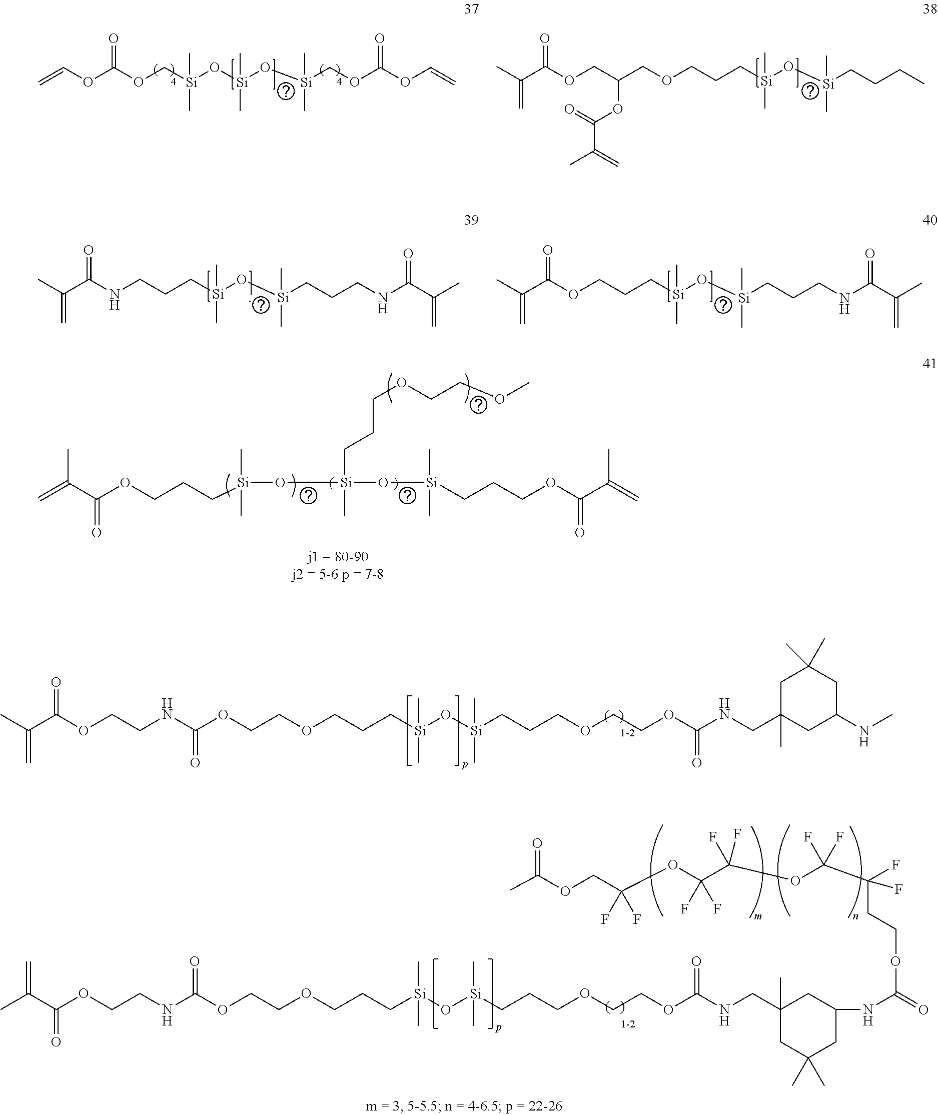

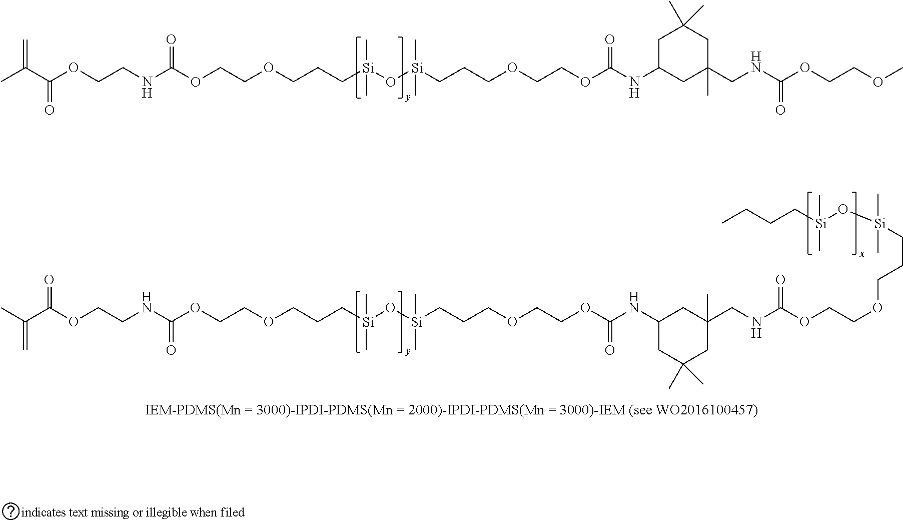

Silicone-containing components may have an average molecular weight of from about 400 to about 4000 daltons.

The silicone containing component(s) may be present in amounts up to about 95 weight %, or from about 10 to about 80 weight %, or from about 20 to about 70 weight %, based upon all reactive components of the reactive mixture (excluding diluents)

Polyamides

The reactive monomer mixture may include at least one polyamide. As used herein, the term “polyamide” refers to polymers and copolymers comprising repeating units containing amide groups. The polyamide may comprise cyclic amide groups, acyclic amide groups and combinations thereof and may be any polyamide known to those of skill in the art. Acyclic polyamides comprise pendant acyclic amide groups and are capable of association with hydroxyl groups. Cyclic polyamides comprise cyclic amide groups and are capable of association with hydroxyl groups.

Examples of suitable acyclic polyamides include polymers and copolymers comprising repeating units of Formulae G1 and G2

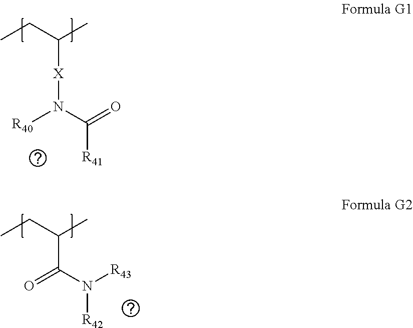

wherein X is a direct bond, —(CO)— or —(CONHR₄₄)—, wherein R₄₄ is a C₁ to C₃ alkyl group; R₄₀ is selected from H, straight or branched, substituted or unsubstituted C₁ to C₄ alkyl groups, R₄₁ is selected from H, straight or branched, substituted or unsubstituted C₁ to C₄ alkyl groups, amino groups having up to two carbon atoms, amide groups having up to four carbon atoms, and alkoxy groups having up to two carbon groups; R₄₂ is selected from H, straight or branched, substituted or unsubstituted C₁ to C₄ alkyl groups, or methyl, ethoxy, hydroxyethyl, and hydroxymethyl; R₄₃ is selected from H, straight or branched, substituted or unsubstituted C₁ to C₄ alkyl groups; or methyl, ethoxy, hydroxyethyl, and hydroxymethyl; wherein the number of carbon atoms in R₄₀ and R₄₁ taken together is 8 or less, including 7, 6, 5, 4, 3, or less; and wherein the number of carbon atoms in R₄₂ and R₄₃ taken together is 8 or less, including 7, 6, 5, 4, 3, or less. The number of carbon atoms in R₄₀ and R₄₁ taken together may be 6 or less or 4 or less. The number of carbon atoms in R₄₂ and R₄₃ taken together may be 6 or less. As used herein substituted alkyl groups include alkyl groups substituted with an amine, amide, ether, hydroxyl, carbonyl or carboxy groups or combinations thereof.

R₄₀ and R₄₁ may be independently selected from H, substituted or unsubstituted C₁ to C₂ alkyl groups. X may be a direct bond, and R₄₀ and R₄₁ may be independently selected from H, substituted or unsubstituted C₁ to C₂ alkyl groups. R₄₂ and R₄₃ can be independently selected from H, substituted or unsubstituted C₁ to C₂ alkyl groups, methyl, ethoxy, hydroxyethyl, and hydroxymethyl.

The acyclic polyamides of the present invention may comprise a majority of the repeating units of Formula LV or Formula LVI, or the acyclic polyamides can comprise at least 50 mole percent of the repeating unit of Formula G or Formula G1, including at least 70 mole percent, and at least 80 mole percent. Specific examples of repeating units of Formula G and Formula G1 include repeating units derived from N-vinyl-N-methylacetamide, N-vinylacetamide, N-vinyl-N-methylpropionamide, N-vinyl-N-methyl-2-methylpropionamide, N-vinyl-2-methyl-propionamide, N-vinyl-N,N′-dimethylurea, N, N-dimethylacrylamide, methacrylamide, and acyclic amides of Formulae G2 and G3:

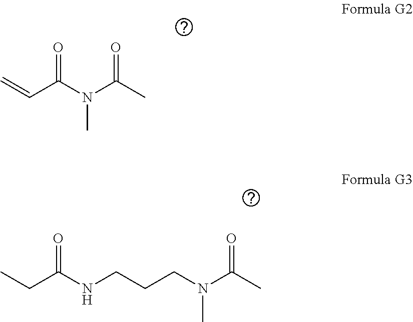

Examples of suitable cyclic amides that can be used to form the cyclic polyamides of include α-lactam, β-lactam, γ-lactam, δ-lactam, and ε-lactam. Examples of suitable cyclic polyamides include polymers and copolymers comprising repeating units of Formula G4:

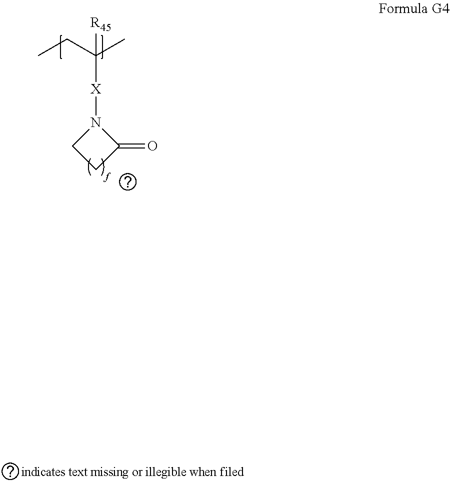

wherein R₄₅ is a hydrogen atom or methyl group, wherein f is a number from 1 to 10; wherein X is a direct bond, —(CO)—, or —(CONHR₄₆)—, wherein R₄₆ is a C₁ to C₃ alkyl group. In Formula LIX, f may be 8 or less, including 7, 6, 5, 4, 3, 2, or 1. In Formula G4, f may be 6 or less, including 5, 4, 3, 2, or 1. In Formula G4, f may be from 2 to 8, including 2, 3, 4, 5, 6, 7, or 8. In Formula LIX, f may be 2 or 3. When X is a direct bond, f may be 2. In such instances, the cyclic polyamide may be polyvinylpyrrolidone (PVP).

Cyclic polyamides may comprise 50 mole percent or more of the repeating unit of Formula G4, or the cyclic polyamides can comprise at least 50 mole percent of the repeating unit of Formula G4, including at least 70 mole percent, and at least 80 mole percent.

The polyamides may also be copolymers comprising repeating units of both cyclic and acyclic amides. Additional repeating units may be formed from monomers selected from hydroxyalkyl(meth)acrylates, alkyl(meth)acrylates, other hydrophilic monomers and siloxane substituted (meth)acrylates. Any of the monomers listed as suitable hydrophilic monomers may be used as comonomers to form the additional repeating units. Specific examples of additional monomers which may be used to form polyamides include 2-hydroxyethyl (meth)acrylate, vinyl acetate, acrylonitrile, hydroxypropyl (meth)acrylate, methyl (meth)acrylate and hydroxybutyl (meth)acrylate, dihydroxypropyl (meth)acrylate, polyethylene glycol mono(meth)acrylate, and the like and mixtures thereof. Ionic monomers may also be included. Examples of ionic monomers include (meth)acrylic acid, N-[(ethenyloxy)carbonyl]-β-alanine (VINAL, CAS #148969-96-4), 3-acrylamidopropanoic acid (ACA1), 5-acrylamidopentanoic acid (ACA2), 3-acrylamido-3-methylbutanoic acid (AMBA), 2-(methacryloyloxy)ethyl trimethylammonium chloride (Q Salt or METAC), 2-acrylamido-2-methylpropane sulfonic acid (AMPS), 1-propanaminium, N-(2-carboxyethyl)-N,N-dimethyl-3-[(1-oxo-2-propen-1-yl)amino]-, inner salt (CBT), I-propanaminium, N,N-dimethyl-N-[3-[(1-oxo-2-propen-1-yl)amino]propyl]-3-sulfo-, inner salt (SBT), 3,5-Dioxa-8-aza-4-phosphaundec-10-en-1-aminium, 4-hydroxy-N,N,N-trimethyl-9-oxo-, inner salt, 4-oxide (9CI) (PBT), 2-methacryloyloxyethyl phosphorylcholine, 3-(dimethyl(4-vinylbenzyl)ammonio)propane-1-sulfonate (DMVBAPS), 3-((3-acrylamidopropyl)dimethylammonio)propane-1-sulfonate (AMPDAPS), 3-((3-methacrylamidopropyl)dimethylammonio)propane-1-sulfonate (MAMPDAPS), 3-((3-(acryloyloxy)propyl)dimethylammonio)propane-1-sulfonate (APDAPS), 3-((3-(methacryloyloxy)propyl)dimethylammonio)propane-1-sulfonate (MAPDAPS).

The reactive monomer mixture may comprise both an acyclic polyamide and a cyclic polyamide or copolymers thereof. The acyclic polyamide can be any of those acyclic polyamides described herein or copolymers thereof, and the cyclic polyamide can be any of those cyclic polyamides described herein or copolymers thereof. The polyamide may be selected from the group polyvinylpyrrolidone (PVP), polyvinylmethylacetamide (PVMA), polydimethylacrylamide (PDMA), polyvinylacetamide (PNVA), poly hydroxyethyl (meth)acrylamide, polyacrylamide, and copolymers and mixtures thereof.

The total amount of all polyamides in the reactive mixture may be in the range of between 1 weight percent and about 35 weight percent, including in the range of about 1 weight percent to about 15 weight percent, and in the range of about 5 weight percent to about 15 weight percent, in all cases, based on the total weight of the reactive components of the reactive monomer mixture.

Without intending to be bound by theory, when used with a silicone hydrogel, the polyamide functions as an internal wetting agent. The polyamides may be non-polymerizable, and in this case, are incorporated into the silicone hydrogels as semi-interpenetrating networks. The polyamides are entrapped or physically retained within the silicone hydrogels. Alternatively, the polyamides may be polymerizable, for example as polyamide macromers or prepolymers, and in this case, are covalently incorporated into the silicone hydrogels. Mixtures of polymerizable and non-polymerizable polyamides may also be used.

When the polyamides are incorporated into the reactive monomer mixture they may have a weight average molecular weight of at least 100,000 daltons, greater than about 150,000; between about 150,000 to about 2,000,000 daltons; between about 300,000 to about 1,800,000 daltons. Higher molecular weight polyamides may be used if they are compatible with the reactive monomer mixture

Cross-Linking Agents

It is generally desirable to add one or more cross-linking agents, also referred to as cross-linking monomers, multi-functional macromers, and prepolymers, to the reactive mixture. The cross-linking agents may be selected from bifunctional crosslinkers, trifunctional crosslinkers, tetrafunctional crosslinkers, and mixtures thereof, including silicone-containing and non-silicone containing cross-linking agents. Non-silicone-containing cross-linking agents include ethylene glycol dimethacrylate (EGDMA), tetraethylene glycol dimethacrylate (TEGDMA), trimethylolpropane trimethacrylate (TMPTMA), triallyl cyanurate (TAC), glycerol trimethacrylate, methacryloxyethyl vinylcarbonate (HEMAVc), allyl methacrylate, methylene bisacrylamide (MBA), and polyethylene glycol dimethacrylate wherein the polyethylene glycol has a molecular weight up to about 5000 Daltons. The cross-linking agents are used in the usual amounts, e.g., from about 0.000415 to about 0.0156 mole per 100 grams of reactive Formulas in the reactive mixture. Alternatively, if the hydrophilic monomers and/or the silicone-containing components are multifunctional by molecular design or because of impurities, the addition of a cross-linking agent to the reactive mixture is optional. Examples of hydrophilic monomers and macromers which can act as the cross-linking agents and when present do not require the addition of an additional cross-linking agent to the reactive mixture include (meth)acrylate and (meth)acrylamide endcapped polyethers Other cross-linking agents will be known to one skilled in the art and may be used to make the silicone hydrogel of the present invention.

It may be desirable to select crosslinking agents with similar reactivity to one or more of the other reactive components in the formulation. In some cases, it may be desirable to select a mixture of crosslinking agents with different reactivity in order to control some physical, mechanical or biological property of the resulting silicone hydrogel. The structure and morphology of the silicone hydrogel may also be influenced by the diluent(s) and cure conditions used.

Multifunctional silicone-containing components, including macromers, cross-linking agents, and prepolymers, may also be included to further increase the modulus and retain tensile strength. The silicone containing cross-linking agents may be used alone or in combination with other cross-linking agents. An example of a silicone containing component which can act as a cross-linking agent and, when present, does not require the addition of a crosslinking monomer to the reactive mixture includes α,ω-bismethacryloxypropyl polydimethylsiloxane.

Cross-linking agents that have rigid chemical structures and polymerizable groups that undergo free radical polymerization may also be used. Non-limiting examples of suitable rigid structures include cross-linking agents comprising phenyl and benzyl moieties, such are 1,4-phenylene diacrylate, 1,4-phenylene dimethacrylate, 2,2-bis(4-methacryloxyphenyl)-propane, 2,2-bis[4-(2-acryloxyethoxy)phenyl]propane, 2,2-bis[4-(2-hydroxy-3-methacryloxypropoxy)-phenyl]propane, and 4-vinylbenzyl methacrylate, and combinations thereof. Rigid crosslinking agents may be included in amounts between about 0.5 and about 15, or 2-10, 3-7 based upon the total weight of all of the reactive components. The physical and mechanical properties of the silicone hydrogels of the present invention may be optimized for a particular use by adjusting the components in the reactive mixture.

Non-limiting examples of silicone cross-linking agents also include the multi-functional silicone-containing components described above, such as compounds of Formula E (and its sub-formulae) and the multi-functional compounds shown in the tables above.

When the compositions described herein are used in silicone hydrogel contact lenses, the lens may preferably exhibit the following properties. All values are prefaced by “about,” and the lens may have any combination of the listed properties. The properties may be determined by methods known to those skilled in the art for instance as described in United States pre-grant publication US20180037690, which is incorporated herein by reference.

Water content weight % at least 20%, at least 25%, at least about 30%, or at least about 35%, and up to 80% or up to 70%

Haze: 30% or less, or 10% or less

Advancing dynamic contact angle (Wilhelmy plate method): 100° or less, or 80° or less; or 50° or less

Tensile Modulus (psi): 120 or less, or 80 to 120

Oxygen permeability (Dk, barrers): at least 80, or at least 100, or at least 150, or at least 200

Elongation to Break: at least 100

For ionic silicon hydrogels, the following properties may also be preferred (in addition to those recited above).

Lysozyme uptake (μg/lens): at least 100, or at least 150, or at least 500, or at least 700

Polyquaternium 1 (PQ1) uptake (%): 15 or less, or 10 or less, or 5 or less

### EXAMPLES

The present disclosure comprises at least the following examples. The examples below are intended to further illustrate certain aspects of the materials and methods described herein, and is not intended to limit the scope of the claims.

Aspect 1: A composition for light filtering, the composition comprising, a base material; a plurality of gold nanoparticles dispersed in the base material, wherein the plurality of gold nanoparticles exhibit a peak light absorption value in the range of about 650 nm to about 800 nm, a chemical dye dispersed in the base material, the chemical dye having an emission peak that at least partially overlaps with the peak light absorption of the plurality of gold nanoparticles; and a nanoparticle coating material disposed on at least a portion of the plurality of gold nanoparticles.

Aspect 2: The composition of aspect 1, wherein the composition exhibits an absorption spectrum having a full-width at half maximum of about 58 nm-118 nm.

Aspect 3: The composition of any one of aspects 1-2, wherein the base material comprises a biomaterial.

Aspect 4: The composition of any one of aspects 1-2, wherein the base material comprises a biomaterial matrix.

Aspect 5: The composition of any one of aspects 1-2, wherein the base material comprises hydrogel.

Aspect 6: The composition of any one of aspects 1-2, wherein the base material comprises silicone-based hydrogel.

Aspect 7: The composition of any one of aspects 1-2, wherein the base material comprises a HEMA-based material.

Aspect 8: The composition of any one of aspects 1-7, wherein at least a portion of the plurality of gold nanoparticles have a star shape.

Aspect 9: The composition of claim 1, wherein a shape of at least a portion of the plurality of gold nanoparticles is tuned such that the portion of the plurality of gold nanoparticles exhibits a peak light absorption in the range of about 650 nm to about 800 nm.

Aspect 10. The composition of claim 1, wherein the chemical dye comprises Rhodamine-based dye.

Aspect 11: The composition of claim 1, wherein the chemical dye comprises one or more of Rhodamine B, Rhodamine 6G, or TRITC

Aspect 12: The composition of claim 1, wherein the nanoparticle coating material comprises terminally thiolated poly(ethyleneglycol).

Aspect 13: The composition of claim 1, wherein the nanoparticle coating material comprises poly(vinyl pyrrolidone).

Aspect 14: The composition of claim 1, wherein a shape of at least a portion of the plurality of gold nanoparticles is tuned to effect fluorescence quenching.

Aspect 15: A method of making the composition of claim 1.

Aspect 16: A composition for light filtering, the composition comprising: a base material; a plurality of nanoparticles dispersed in the base material, wherein the plurality of nanoparticles exhibit a peak light absorption value in the range of about 650 nm to about 800 nm; a chemical dye dispersed in the base material, the chemical dye having an abortion peak in the range of about 530 nm to about 560 nm; and a nanoparticle coating material disposed on at least a portion of the plurality of nanoparticles.

Aspect 17: The composition of claim 16, wherein the composition exhibits an absorption spectrum having a full-width at half maximum of about 58 nm-118 nm.

Aspect 18: The composition of claim 16, wherein the base material comprises a biomaterial.

Aspect 19: The composition of claim 16, wherein the base material comprises a biomaterial matrix.

Aspect 20: The composition of claim 16, wherein the base material comprises hydrogel.

Aspect 2: The composition of claim 16, wherein the base material comprises a HEMA-based material.

Aspect 22: The composition of claim 16, wherein at least a portion of the plurality of nanoparticles have a star shape.

Aspect 23: The composition of claim 16, wherein a shape of at least a portion of the plurality of nanoparticles is tuned such that the portion of the plurality of nanoparticles exhibits a peak light absorption in the range of about 650 nm to about 800 nm.

Aspect 24: The composition of claim 16, wherein the chemical dye comprises Rhodamine-based dye.

Aspect 25: The composition of claim 16, wherein the chemical dye comprises one or more of Rhodamine 13, Rhodamine 6G, or TRITC.

Aspect 26: The composition of claim 16, wherein the nanoparticle coating material comprises terminally thiolated poly(ethyleneglycol).

Aspect 27: The composition of claim 16, wherein the nanoparticle coating material comprises poly(vinyl pyrrolidone).

Aspect 28: The composition of claim 16, wherein a shape of at least a portion of the plurality of nanoparticles is tuned to effect fluorescence quenching.

Aspect 29: The composition of claim 16, wherein the nanoparticles comprise plasmonic nanoparticles.

Aspect 30: The composition of claim 16, wherein the nanoparticles comprise metal nanoparticles.

Aspect 31: The composition of claim 16, wherein the nanoparticles comprise gold nanoparticles.

Aspect 32: A method of making the composition of claim 16.

Aspect 33: A composition for light filtering, the composition comprising: a base material; a plurality of nanoparticles dispersed in the base material, wherein the plurality of nanoparticles exhibit a peak light absorption value in the range of about 650 nm to about 800 nm; a chemical dye dispersed in the base material, the chemical dye having a spectral peak that is at least partially quenched by the filtering of the spectral curve of the nanoparticles; an anchoring mechanism dispersed in the base material, the anchoring mechanism comprising methacryloyl-derived monomer; and a nanoparticle coating material disposed on at least a portion of the plurality of nanoparticles.

Aspect 34: The composition of claim 33, wherein the composition exhibits an absorption spectrum having a full-width at half maximum of about 58 nm-118 nm.

Aspect 35: The composition of claim 33, wherein the base material comprises a biomaterial.

Aspect 36: The composition of claim 33, wherein the base material comprises a biomaterial matrix.

Aspect 37: The composition of claim 33, wherein the base material comprises hydrogel.

Aspect 38: The composition of claim 33, wherein the base material comprises a HEMA-based material.

Aspect 39: The composition of claim 33, wherein at least a portion of the plurality of nanoparticles have a star shape.

Aspect 40: The composition of claim 33, wherein a shape of at least a portion of the plurality of nanoparticles is tuned such that the portion of the plurality of exhibits a peak light absorption in the range of about 650 nm to about 800 nm.

Aspect 41: The composition of claim 33, wherein the chemical dye comprises Rhodamine-based dye.

Aspect 42: The composition of claim 33, wherein the chemical dye comprises one or more of Rhodamine B. Rhodamine 6G, or TRITC.

Aspect 43: The composition of claim 33, wherein the anchoring mechanism comprises glycidyl methacrylate.

Aspect 44: The composition of claim 33, wherein the nanoparticle coating material comprises poly(vinyl alcohol).

Aspect 45: The composition of claim 33, wherein a shape of at least a portion of the plurality of nanoparticles is tuned to effect fluorescence quenching.

Aspect 46: The composition of claim 33, wherein the nanoparticles comprise plasmonic nanoparticles.

Aspect 47: The composition of claim 33, wherein the nanoparticles comprise metal nanoparticles.

Aspect 48: The composition of claim 33, wherein the nanoparticles comprise gold nanoparticles.

Aspect 49: A method of making the composition of claim 33.

A strategy wherein the specific light blocking of dyes with the fluorescence quenching of gold nanoparticles was designed to produce a patient compliant lens (FIGS. 1A-1C).

FIGS. 1A-1C depict a surface modification strategy according to embodiments of the disclosure. The surface modification strategy of the present disclosure was designed to artificially block an area between the red and green cones to improve contrast as it relates to red-green color vision deficiency.

FIGS. 2A-2B depict selection of gold nanostars as the platform for the light blocking material according to embodiments of the disclosure. Gold nanostars were selected as the platform for the light blocking materials, as can be seen in FIG. 2A, which displays an Ultraviolet-Visible (UV-Vis) absorbance spectra of a solution of gold nanostars, normalized to the Localized-Surface Plasmon Resonance (LSPR) peak. The peak was sufficiently close to the target region (and the emission spectra of the dyes) for Forster Resonance Energy Transfer (FRET) (i.e. fluorescence quenching) to occur, but far enough removed that it did not contribute significantly to the overall light blocking profile. Since the nanostars blocked in the red light region, the solution appeared blue. A representative Transmission Electron Microscopy (TEM) micrograph of gold (Au) nanostars can be seen in FIG. 2B.

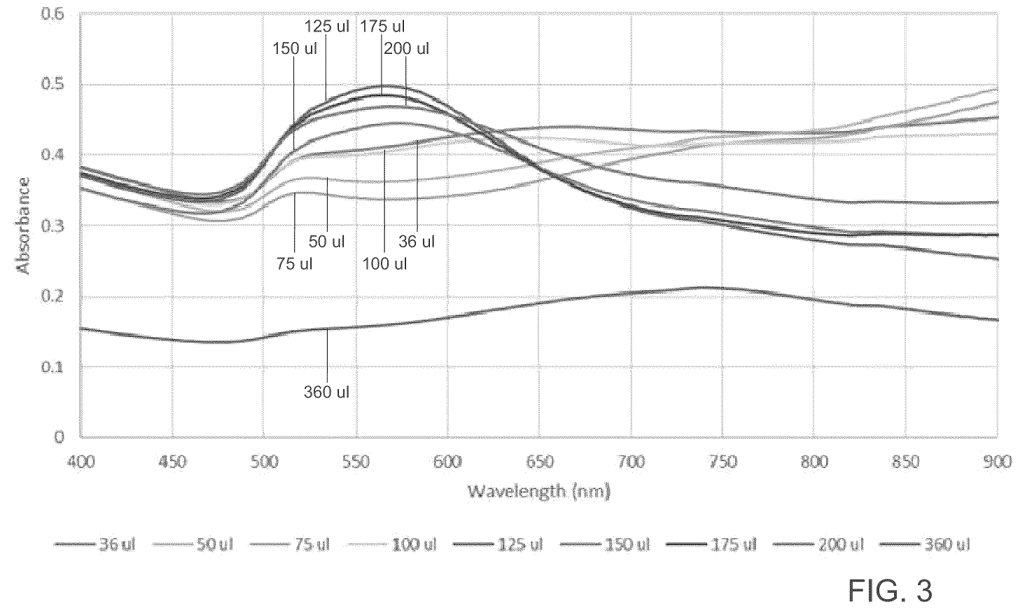

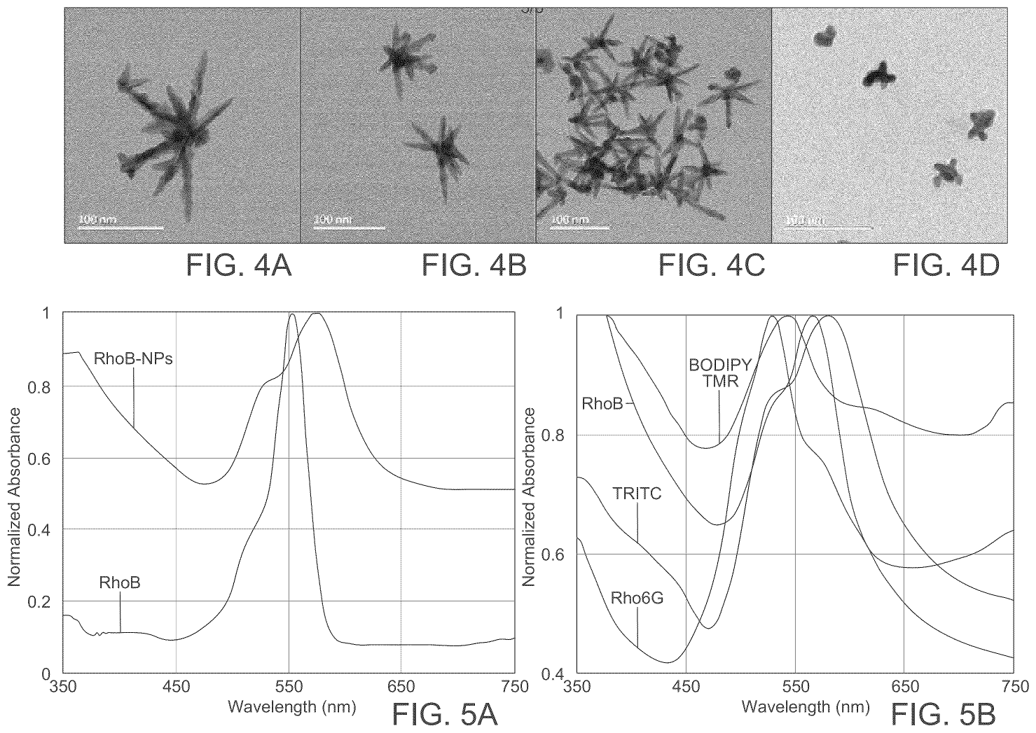

Gold nanostars were selected for the light blocking materials. Gold nanostars blocked light at longer wavelengths than the target region (530-560 nm), as can be seen in FIG. 2A. However, the LSPR peak was close enough to the emission spectra of fluorescent dyes that fluorescence quenching could still occur via FRET. TEM micrographs of the gold nanostars confirmed the expected morphology (a small core with 4-6 branches, approximately 10-20 nm each), as can be seen in FIG. 2B. The size and length of the branches may be modified to block in different red light regions to tailor the color profile and achieve FRET fluorescence quenching with different dyes. As a non-limiting example, these modifications in size and length of gold nanostar branches may result from alteration of the amount of seed used. To show this, gold nanostars were grown keeping all parameters the same but altering amount of seed added from 36 μl to 360 μl (FIG. 3), resulting in various sizes and “spikiness” of the resultant gold nanostars. TEM images were created to display morphologies of gold nanostars synthesized with 36 μl (FIG. 4A), 100 μl (FIG. 4B), 150 μl (FIG. 4C), and 360 μl (FIG. 4D).

The nanostars were initially synthesized with thiol-terminated poly(ethylene glycol) (PEG-SH) Cystamine, or another suitable, small multifunctional compound, was then used to tether the organic dye to the nanostar surface, as described below.

Stock solutions of 15 mM cystamine and 0.15 mM Rhodamine B—N-hydroxysuccinimide (RhoB-NHS) were prepared in a buffer of 100 mM NaHCO₃ in MilliQ. Cystamine (2 ml) and RhoB-NHS (1 ml) were then mixed in a scintillation vial and reacted at 4° C. for 4 hrs.

In a 20-ml scintillation vial, 2 mM trisodium citrate (1 ml), 25.4 mM HAuCl4 (0.188 ml), and 0.1 M ice-cold NaBH4 (60 μl) were added sequentially to MilliQ (18.822 ml). This solution was stirred vigorously until reaction completion to form nanoseeds. In a second 20-ml scintillation vial, 11 mM HAuCl4 (0.64 ml), 10 mM AgNO3 (0.2 ml) and 0.1 M L-ascorbic acid (0.103 ml, added dropwise) were added sequentially to 7.33 mM CTAB (15 ml). Upon addition of the last drop of L-ascorbic acid, the solution turned clear and a desired volume of nanoseed was added (e.g., 150 μl). These samples were stirred moderately until reaction completion. The nanoparticles were then centrifuged (15,000 rpm for 10 min), the supernatant was removed, and the nanoparticles were resuspended in a mixture of dye-cystamine (3 ml) and either 100 mM PEG-SH or polyvinylpyrrolidone (PVP) (1 ml, in MilliQ). The samples were left undisturbed in the fume hood overnight and used beginning the next day.

Dye-conjugated NPs were centrifuged at 12,000×g for 15 mins and resuspended in 5 ml MilliQ until loss of color in the supernatant (˜3-4 times). Aliquots of the purified dye-NPs (300 μl) were collected and added to a 96-well microplate (96-Well Microplates, Polystyrene, Clear, Greiner Bio-One, Cat. No. 82050-760) for analysis using UV-Vis spectrophotometry (step size: 1 nm, number of flashes: 8, Tecan Infinite M Plex spectrophotometer). TEM samples were prepared by drop casting the respective solution (5 μl) on a 400-mesh pure C, Cu grid (Ted Pella, Inc., Redding, USA) and dried under hood evaporation. Before drop casting, NPs were prepared via centrifugation and resuspension in MilliQ to remove residual capping agents. Grids were cleaned via ultraviolet light (6 min per side) before imaging. TEM images were acquire using a Hitachi HF-3300 300 kV Environmental TEM with an electron acceleration voltage of 300 kV.

FIGS. 5A-5B depict a spectra of dye-nanoparticle (dye-NP) light blockers in solution according to embodiments of the disclosure. FIGS. 5A-5B are spectra of dye-NP light blockers in solution, showing UV-Vis spectroscopy absorbance profiles in water. FIG. 5A depicts Rhodamine B dye (RhoB) dissolved in water and RhoB-conjugated gold nanostars (RhoB-NPs). FIG. 5B depicts various dyes conjugated to gold nanostars with peaks spanning the target range, wherein “TRITC” refers to “tetramethylrhodamine isothiocyanate” All UV-Vis data on dye-NPs was collected after samples were centrifuged at 12,000×g for 15 min to remove any excess dye until the supernatant was colorless.

Upon conjugation to the gold nanostars via 1-Ethyl-3-3-dimethylaminopropyl)carbodiimide/N-hydroxysuccinimide (EDC/NHS) click chemistry, the Rhodamine B dye retained its selective light blocking peak with some broadening and red-shifting, as can be seen in FIG. 5A. The light blocking platform could also be adapted to a variety of commercially available dyes to produce tailored light blocking profiles, as can be seen in FIG. 5B.

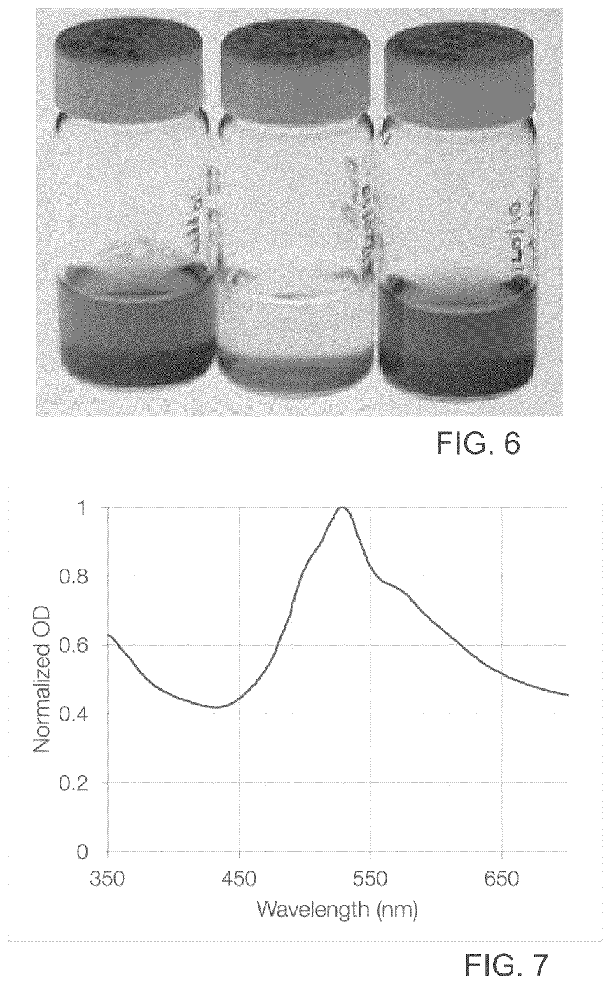

FIG. 6 depicts a color profile of dye-NP light blocker compared to existing methods according to embodiments of the disclosure. FIG. 6 shows a direct comparison of gold nanospheres blocking in the target range, RhoB dye in water and the dye-NP combination in solution (i.e, from FIGS. 5A-5B). The resultant color profile in the dye-NP combination was purple (pink/red from dye, blue from nanostars) and less bright and intense compared to the dye on its own.

The color profile of dye-NP light blocker was shown compared to existing methods Color profile differences are shown in FIG. 6 between AuNPs (left), dye (middle) and dye-conjugated AuNP nanostars (right). The AuNP nanostars softened the sharp pink color of the dye to produce a more patient-compliant purple without sacrificing the specific light blocking of the dye.

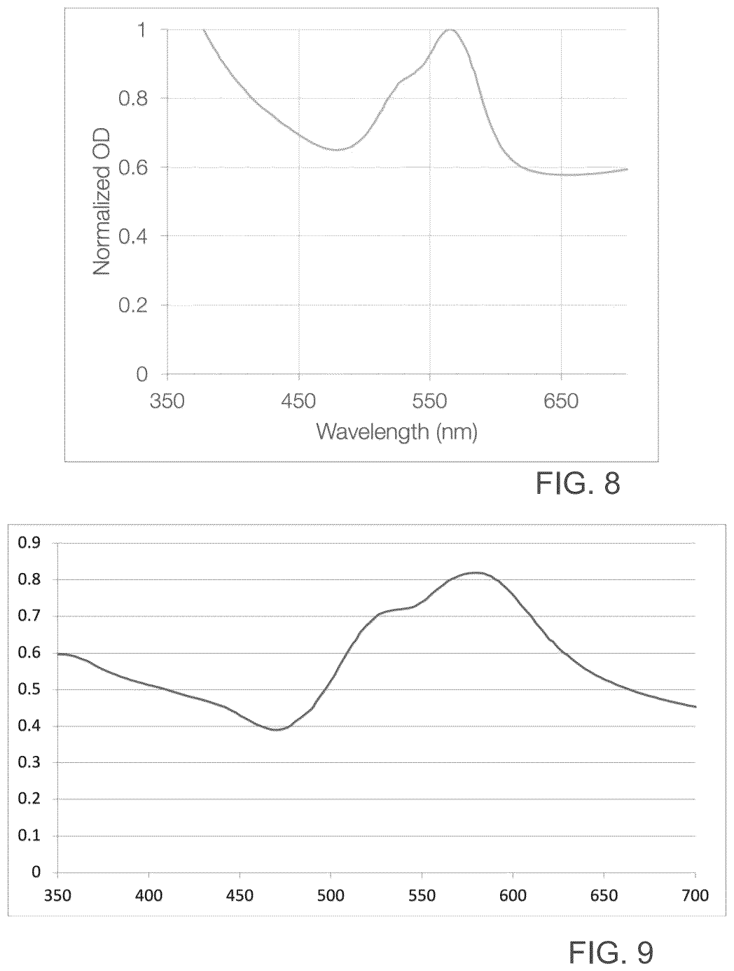

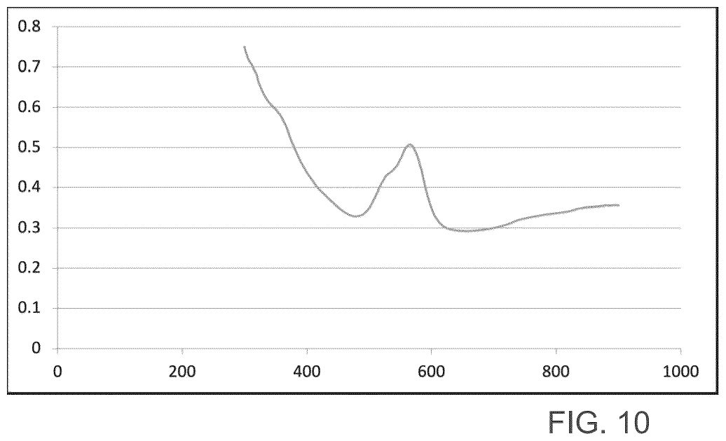

FIGS. 7-10 display various absorbance spectra of nanoparticles with varying surface chemistries. Nanoparticles conjugated to varying rhodamine dyes were synthesized including, but not limited to, Rhodamine 6G, Rhodamine B, tetramethylrhodamine (TRITC), and 5-carboxy-tetramethylrhodamine. These varying nanoparticles were capable of being tuned to have a variety of Full Width Half Maximum (FWHM) values including, but not limited to, 97 nm for Rhodamine 6G nanoparticle light filters in solution (FIG. 7), 70 nm for Rhodamine B nanoparticle light filters in solution (FIG. 8), 118 nm for tetramethylrhodamine (TRITC) nanoparticle light filters in solution (FIG. 9), and 70 nm for 5-carboxy-tetramethylrhodamine nanoparticle light filters in solution (FIG. 10). Such results demonstrated an ability to conjugate nanoparticles to a variety of rhodamine dyes, though it should be appreciated that the method may be applicable to any NHS-functionalized dye and other dyes functionalized in additional manners. Such conjugations were motivated by desired target wavelength absorptions and resulted in tunable target wavelength absorption and FWHM values.

Gold nanostars conjugated to organic dyes and stabilizing mechanisms (e.g. PVP, PEG-SH, etc.) have been synthesized as described above. An exemplary process for conjugating anchoring mechanisms to gold nanostars to form nanoparticles simultaneously conjugated to organic dyes, stabilizing mechanisms, and anchoring mechanisms has been modified from Hermanson, G. T., Bioconjugate Techniques. Third Edition. Elsevier Inc. (2013) and Vu-Quang H., et al, Polymers (Basel) (2019) and is now described. First, 10 mM Rhodamine B (RhoB) (2 ml, in anhydrous dimethylsulfoxide (DMSO)) is mixed with 23 μmol of carbonyldiimidazole (CDI) CDI should be added directly to DMSO and not dissolved beforehand. The mixture is protected from light and reacted in the fume hood under vigorous stirring for >24 hrs. As shown above, the organic dye does not need to be Rhodamine B and could be a number of organic dyes known in the art. Next, 200 mM polyvinyl alcohol (PVA) (5 ml, in anhydrous DMSO) is added to the RhoB-CDI solution, wherein PVA may serve as an anchoring mechanism, and the mixture is once again protected from light and reacted in the fume hood under vigorous stirring for >24 hrs. This process uses CDI as a zero-length crosslinker to conjugate RhoB with PVA via esterification. The polymer does not need to be PVA and could be a number of polymers and similar compounds known in the art. Once the reaction is completed, the solution is dialyzed against 4 L MilliQ water for >24 hrs with repeated medium changes and then lyophilized. The RhoB-PVA can now be used to coat the gold nanoparticles (AuNPs). By introducing various amounts of RhoB-PVA (for specific light blocking and methacrylation), additional unfunctionalized PVA (for methacrylation), and PVP (for stabilization), we can produce a full complement of dye and stabilizing and anchoring mechanisms, wherein anchoring mechanisms may comprise methacrylation, on the same nanoparticle.

The systems, methods, compositions, and devices of the appended claims are not limited in scope by the specific materials and devices described herein, which are intended as illustrations of a few aspects of the claims. Any systems, methods, compositions, and devices that are functionally equivalent are intended to fall within the scope of the claims. Various modifications of the systems, methods, compositions, and devices in addition to those shown and described herein are intended to fall within the scope of the appended claims. Further, while only certain representative systems, methods, compositions, and devices disclosed herein are specifically described, other combinations of the systems, methods, compositions, and devices are also are intended to fall within the scope of the appended claims, even if not specifically recited Thus, a combination of elements, components, or constituents may be explicitly mentioned herein or less, however, other combinations of elements, components, and constituents are included, even though not explicitly stated.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs Publications cited herein and the materials for which they are cited are specifically incorporated by reference.

What is claimed is:

1. A composition for light filtering, the composition comprising:
a base material;
a plurality of gold nanoparticles dispersed in the base material, wherein the plurality of gold nanoparticles exhibit a peak light absorption value in the range of about 650 nm to about 800 nm;
a chemical dye dispersed in the base material, the chemical dye having an emission peak that at least partially overlaps with the peak light absorption of the plurality of gold nanoparticles; and
a nanoparticle coating material disposed on at least a portion of the plurality of gold nanoparticles.

2. The composition of claim 1, wherein the composition exhibits an absorption spectrum having a full-width at half maximum of about 58 nm-118 nm.

3. The composition of claim 1, wherein the base material comprises a biomaterial.

4. The composition of claim 1, wherein the base material comprises a biomaterial matrix.

5. The composition of claim 1, wherein the base material comprises hydrogel.

6. The composition of claim 1, wherein the base material comprises silicone-based hydrogel.

7. The composition of claim 1, wherein the base material comprises a HEMA-based material.

8. The composition of claim 1, wherein at least a portion of the plurality of gold nanoparticles have a star shape.

9. The composition of claim 1, wherein a shape of at least a portion of the plurality of gold nanoparticles is tuned such that the portion of the plurality of gold nanoparticles exhibits a peak light absorption in the range of about 650 nm to about 800 nm.

10. The composition of claim 1, wherein the chemical dye comprises Rhodamine-based dye.

11. The composition of claim 1, wherein the chemical dye comprises one or more of Rhodamine B, Rhodamine 6G, or TRITC.

12. The composition of claim 1, wherein the nanoparticle coating material comprises terminally thiolated poly(ethyleneglycol).

13. The composition of claim 1, wherein the nanoparticle coating material comprises poly(vinyl pyrrolidone).

14. The composition of claim 1, wherein a shape of at least a portion of the plurality of gold nanoparticles is tuned to effect fluorescence quenching.

15. A method of making the composition of claim 1.

16. A composition for light filtering, the composition comprising:
a base material;
a plurality of nanoparticles dispersed in the base material, wherein the plurality of nanoparticles exhibit a peak light absorption value in the range of about 650 nm to about 800 nm;
a chemical dye dispersed in the base material, the chemical dye having an abortion peak in the range of about 530 nm to about 560 nm; and
a nanoparticle coating material disposed on at least a portion of the plurality of nanoparticles.

17. The composition of claim 16, wherein the composition exhibits an absorption spectrum having a full-width at half maximum of about 58 nm-118 nm.

18. The composition of claim 16, wherein the base material comprises a biomaterial.

19. The composition of claim 16, wherein the base material comprises a biomaterial matrix.

20. The composition of claim 16, wherein the base material comprises hydrogel.

21. The composition of claim 16, wherein the base material comprises a HEMA-based material.

22. The composition of claim 16, wherein at least a portion of the plurality of nanoparticles have a star shape.

23. The composition of claim 16, wherein a shape of at least a portion of the plurality of nanoparticles is tuned such that the portion of the plurality of nanoparticles exhibits a peak light absorption in the range of about 650 nm to about 800 nm.

24. The composition of claim 16, wherein the chemical dye comprises Rhodamine-based dye.

25. The composition of claim 16, wherein the chemical dye comprises one or more of Rhodamine B, Rhodamine 6G, or TRITC.

26. The composition of claim 16, wherein the nanoparticle coating material comprises terminally thiolated poly(ethyleneglycol).

27. The composition of claim 16, wherein the nanoparticle coating material comprises poly(vinyl pyrrolidone).

28. The composition of claim 16, wherein a shape of at least a portion of the plurality of nanoparticles is tuned to effect fluorescence quenching.

29. The composition of claim 16, wherein the nanoparticles comprise plasmonic nanoparticles.

30. The composition of claim 16, wherein the nanoparticles comprise metal nanoparticles.

31. The composition of claim 16, wherein the nanoparticles comprise gold nanoparticles.

32. A method of making the composition of claim 16.

33. A composition for light filtering, the composition comprising:
a base material;
a plurality of nanoparticles dispersed in the base material, wherein the plurality of nanoparticles exhibit a peak light absorption value in the range of about 650 nm to about 800 nm;
a chemical dye dispersed in the base material, the chemical dye having a spectral peak that is at least partially quenched by the filtering of the spectral curve of the nanoparticles;
an anchoring mechanism dispersed in the base material, the anchoring mechanism comprising methacryloyl-derived monomer; and
a nanoparticle coating material disposed on at least a portion of the plurality of nanoparticles.

34. The composition of claim 33, wherein the composition exhibits an absorption spectrum having a full-width at half maximum of about 58 nm-118 nm.

35. The composition of claim 33, wherein the base material comprises a biomaterial.

36. The composition of claim 33, wherein the base material comprises a biomaterial matrix.

37. The composition of claim 33, wherein the base material comprises hydrogel.

38. The composition of claim 33, wherein the base material comprises a HEMA-based material.

39. The composition of claim 33, wherein at least a portion of the plurality of nanoparticles have a star shape.

40. The composition of claim 33, wherein a shape of at least a portion of the plurality of nanoparticles is tuned such that the portion of the plurality of exhibits a peak light absorption in the range of about 650 nm to about 800 nm.

41. The composition of claim 33, wherein the chemical dye comprises Rhodamine-based dye.

42. The composition of claim 33, wherein the chemical dye comprises one or more of Rhodamine B, Rhodamine 6G, or TRITC.

43. The composition of claim 33, wherein the anchoring mechanism comprises glycidyl methacrylate.

44. The composition of claim 33, wherein the nanoparticle coating material comprises poly(vinyl alcohol).

45. The composition of claim 33, wherein a shape of at least a portion of the plurality of nanoparticles is tuned to effect fluorescence quenching.

46. The composition of claim 33, wherein the nanoparticles comprise plasmonic nanoparticles.

47. The composition of claim 33, wherein the nanoparticles comprise metal nanoparticles.

48. The composition of claim 33, wherein the nanoparticles comprise gold nanoparticles.

49. A method of making the composition of claim 33.

50. A contact lens that is a free radical reaction product of a reactive mixture comprising: one or more silicone-containing components and one or more hydrophilic components; the contact lens having a water content of at least about 20 weight percent and an oxygen permeability of at least about 80 barrers, wherein the contact lens further comprises a composition for light filtering, the composition containing:
a plurality of nanoparticles dispersed in the contact lens, wherein the plurality of nanoparticles exhibit a peak light absorption value in the range of about 650 nm to about 800 nm;
a chemical dye dispersed in the contact lens, the chemical dye having a spectral peak that is at least partially quenched by the filtering of the spectral curve of the nanoparticles;
an anchoring mechanism dispersed in the contact lens, the anchoring mechanism comprising methacryloyl-derived monomer; and
a nanoparticle coating material disposed on at least a portion of the plurality of nanoparticles.

51. The contact lens of claim 50, wherein the composition exhibits an absorption spectrum having a full-width at half maximum of about 58 nm-118 nm.

52. The contact lens of claim 50, wherein at least a portion of the plurality of nanoparticles have a star shape.

53. The contact lens of claim 50, wherein a shape of at least a portion of the plurality of nanoparticles is tuned such that the portion of the plurality of exhibits a peak light absorption in the range of about 650 nm to about 800 nm.

54. The contact lens of claim 50, wherein the chemical dye comprises Rhodamine-based dye.

55. The contact lens of claim 50, wherein the chemical dye comprises one or more of Rhodamine B, Rhodamine 6G, or TRITC.

56. The contact lens of claim 50, wherein the anchoring mechanism comprises glycidyl methacrylate.

57. The contact lens of claim 50, wherein the nanoparticle coating material comprises poly(vinyl alcohol).

58. The contact lens of claim 50, wherein a shape of at least a portion of the plurality of nanoparticles is tuned to effect fluorescence quenching.

59. The contact lens of claim 50, wherein the nanoparticles comprise plasmonic nanoparticles.

60. The contact lens of claim 50, wherein the nanoparticles comprise metal nanoparticles.

61. The contact lens of claim 50, wherein the nanoparticles comprise gold nanoparticles.
